(19) United States
(12) Patent Application Publication
(10) Pub. No.: US 2023/0147816 A1
(43) Pub. Date: May 11, 2023

(54) FEATURES FOR ONLINE DISCUSSION FORUMS

(71) Applicant: Alpha Exploration Co. d/b/a/ Clubhouse, San Francisco, CA (US)

(72) Inventors: Justin Uberti, San Francisco, CA (US); Molly Nix, San Francisco, CA (US)

(21) Appl. No.: 17/983,252

(22) Filed: Nov. 8, 2022

Related U.S. Application Data
(60) Provisional application No. 63/277,056, filed on Nov. 8, 2021.
(60) Provisional application No. 63/280,404, filed on Nov. 17, 2021.

(51) Int. Cl. G10L 15/26

(52) U.S. Cl. CPC G10L 15/26

(57) ABSTRACT

A method for providing transcripts in online audio discussion forums. The method includes generating an audio discussion forum for a plurality of users, the plurality of users including at least a first user and a second user, receiving a first audio stream corresponding to first audio content associated with the first user, receiving a second audio stream corresponding to second audio content associated with the second user, the second audio stream being separate from the first audio stream, transcribing the first audio content of the first audio stream into first text content, transcribing the second audio content of the second audio stream into second text content, and creating a transcript for the audio discussion forum based on the first text content and the second text content.

### CROSS-REFERENCE TO RELATED APPLICATIONS

This application claims priority to and the benefit of U.S. Provisional Patent Application No. 63/277,056 titled “FEATURES FOR ONLINE DISCUSSION FORUMS” and filed on Nov. 8, 2021, and U.S. Provisional Patent Application No. 63/280,404 titled “FEATURES FOR ONLINE DISCUSSION FORUMS” and filed on Nov. 17, 2021, the entire contents of which are hereby incorporated by reference herein.

### TECHNICAL FIELD

This specification relates to online discussion forums and, in particular, to online audio discussion forums in which users participate as speakers and audience members in virtual audio rooms.

### BACKGROUND

An online discussion forum such as a message board, or a social media website, provides an online forum where users can hold discussions by posting messages. In message boards, text-based messages posted for a particular topic can be grouped into a thread, often referred to as a conversation thread. A user interface (e.g., a web page) for an online forum can contain a list of threads or topics. In social media websites, users are typically followed by other users and/or select other users to follow. In this context, “follow” means being able to see content posted by the followed user. Users typically select other users to follow based on the identity of the other users, which is provided by the social media platform, e.g., by providing a real name, a user name, and/or a picture. However, text-based online discussion forums and social media websites can have slow moving discussions where messages or posts are exchanged over long periods of time (hours, days, etc.). As such, these online discussions can be less interactive and dynamic relative to in-person discussions or telephone discussions.

### SUMMARY

At least one aspect of the present disclosure is directed to a method for providing transcripts in online audio discussion forums. The method includes generating an audio discussion forum for a plurality of users, the plurality of users including at least a first user and a second user, receiving a first audio stream corresponding to first audio content associated with the first user, receiving a second audio stream corresponding to second audio content associated with the second user, the second audio stream being separate from the first audio stream, transcribing the first audio content of the first audio stream into first text content, transcribing the second audio content of the second audio stream into second text content, and creating a transcript for the audio discussion forum based on the first text content and the second text content.

In one embodiment, receiving the first audio stream corresponding to the first audio content associated with the first user includes receiving the first audio stream from a first user device associated with the first user and receiving the second audio stream corresponding to the second audio content associated with the second user includes receiving the second audio stream from a second user device associated with the second user. In some embodiments, the first audio content includes speech content provided by the first user and the second audio content includes speech content provided by the second user. In various embodiments, the first audio content includes speech content provided by the first user and speech content heard by the first user and the second audio content includes speech content provided by the second user and speech content heard by the second user. In certain embodiments, the first and second audio content are transcribed in parallel.

In some embodiments, the first audio content is transcribed while the first user is speaking and the second audio content is transcribed while the second user is speaking. In one embodiment, transcribing the first and second audio content includes providing the first and second audio streams to a common speech recognition module. In certain embodiments, transcribing the first audio content includes providing the first audio stream to a first speech recognition module and transcribing the second audio content includes providing the second audio stream to a second speech recognition module, the second speech recognition module being different than the first speech recognition module. In various embodiments, the method includes selecting the first speech recognition module from a plurality of speech recognition modules based on at least one characteristic of the first user and selecting the second speech recognition module from the plurality of speech recognition modules based on at least one characteristic of the second user.

In one embodiment, the method includes analyzing respective sections of the first text content and the second text content corresponding to a portion of an audio discussion in the audio discussion forum, calculating a first accuracy metric for the first text content section, calculating a second accuracy metric for the second text content section, comparing the first accuracy metric to the second accuracy metric, and based on a result of the comparison, selecting one of the first text content section and the second text content section for inclusion in the transcript for the audio discussion forum. In some embodiments, the first and second accuracy metrics are Levenshtein distances. In various embodiments, the method includes creating a third text content section by replacing at least a portion of the selected text content section with a respective portion of the unselected text content section, calculating a third accuracy metric for the third text content section, comparing the third accuracy metric to the accuracy metric for the selected text content section, and based on a result of the comparison, adding one of the selected text content section and the third text content section to the transcript for the audio discussion forum.

Another aspect of the present disclosure is directed to a system for generating an online audio discussion forum. The system includes at least one memory for storing computer-executable instructions and at least one processor for executing the instructions stored on the memory. Execution of the instructions programs the at least one processor to perform operations that include generating an audio discussion forum for a plurality of users, the plurality of users including at least a first user and a second user, receiving a first audio stream corresponding to first audio content associated with the first user, receiving a second audio stream corresponding to second audio content associated with the second user, the second audio stream being separate from the first audio stream, transcribing the first audio content of the first audio stream into first text content, transcribing the second audio content of the second audio stream into second text content, and creating a transcript for the audio discussion forum based on the first text content and the second text content.

In one embodiment, receiving the first audio stream corresponding to the first audio content associated with the first user includes receiving the first audio stream from a first user device associated with the first user and receiving the second audio stream corresponding to the second audio content associated with the second user includes receiving the second audio stream from a second user device associated with the second user. In some embodiments, the first audio content includes speech content provided by the first user and the second audio content includes speech content provided by the second user. In various embodiments, the first audio content includes speech content provided by the first user and speech content heard by the first user and the second audio content includes speech content provided by the second user and speech content heard by the second user. In certain embodiments, the first and second audio content are transcribed in parallel.

In some embodiments, the first audio content is transcribed while the first user is speaking and the second audio content is transcribed while the second user is speaking. In one embodiment, transcribing the first and second audio content includes providing the first and second audio streams to a common speech recognition module. In certain embodiments, transcribing the first audio content includes providing the first audio stream to a first speech recognition module and transcribing the second audio content includes providing the second audio stream to a second speech recognition module, the second speech recognition module being different than the first speech recognition module. In various embodiments, execution of the instructions programs the at least one processor to perform operations that include selecting the first speech recognition module from a plurality of speech recognition modules based on at least one characteristic of the first user and selecting the second speech recognition module from the plurality of speech recognition modules based on at least one characteristic of the second user.

In one embodiment, execution of the instructions programs the at least one processor to perform operations that include analyzing respective sections of the first text content and the second text content corresponding to a portion of an audio discussion in the audio discussion forum, calculating a first accuracy metric for the first text content section, calculating a second accuracy metric for the second text content section, comparing the first accuracy metric to the second accuracy metric, and based on a result of the comparison, selecting one of the first text content section and the second text content section for inclusion in the transcript for the audio discussion forum. In some embodiments, the first and second accuracy metrics are Levenshtein distances. In various embodiments, execution of the instructions programs the at least one processor to perform operations that include creating a third text content section by replacing at least a portion of the selected text content section with a respective portion of the unselected text content section, calculating a third accuracy metric for the third text content section, comparing the third accuracy metric to the accuracy metric for the selected text content section, and based on a result of the comparison, adding one of the selected text content section and the third text content section to the transcript for the audio discussion forum.

### BRIEF DESCRIPTION OF THE DRAWINGS

FIG. 1 illustrates a block diagram of a system for providing online audio discussion forums in accordance with aspects described herein;

FIG. 2 illustrates a user interface of a client application in accordance with aspects described herein;

FIG. 3 illustrates a flow diagram of a method for starting an audio room in accordance with aspects described herein;

FIG. 4A-4B illustrate a user interface of a client application in accordance with aspects described herein;

FIG. 5 illustrates a flow diagram of a method for pinging users into an audio room in accordance with aspects described herein;

FIGS. 6A-6D illustrate a user interface of a client application in accordance with aspects described herein;

FIG. 7 illustrates a flow diagram of a method for starting an audio room from a chat thread in accordance with aspects described herein;

FIGS. 8A-8B illustrate a user interface of a client application in accordance with aspects described herein;

FIG. 9 illustrates a flow diagram of a method for waving at users to start an audio room in accordance with aspects described herein;

FIGS. 10A-10G illustrate a user interface of a client application in accordance with aspects described herein;

FIGS. 11A-11B illustrate a user interface of a client application in accordance with aspects described herein;

FIGS. 12A-12D illustrate a user interface of a client application in accordance with aspects described herein;

FIGS. 13A-13C illustrate a user interface of a client application in accordance with aspects described herein;

FIG. 14 illustrates a user interface of a client application in accordance with aspects described herein;

FIG. 15 illustrates a block diagram of an audio service arrangement in accordance with aspects described herein;

FIG. 16 illustrates a block diagram of an audio processing architecture in accordance with aspects described herein; and

FIG. 17 illustrates an example computing device.

### DETAILED DESCRIPTION

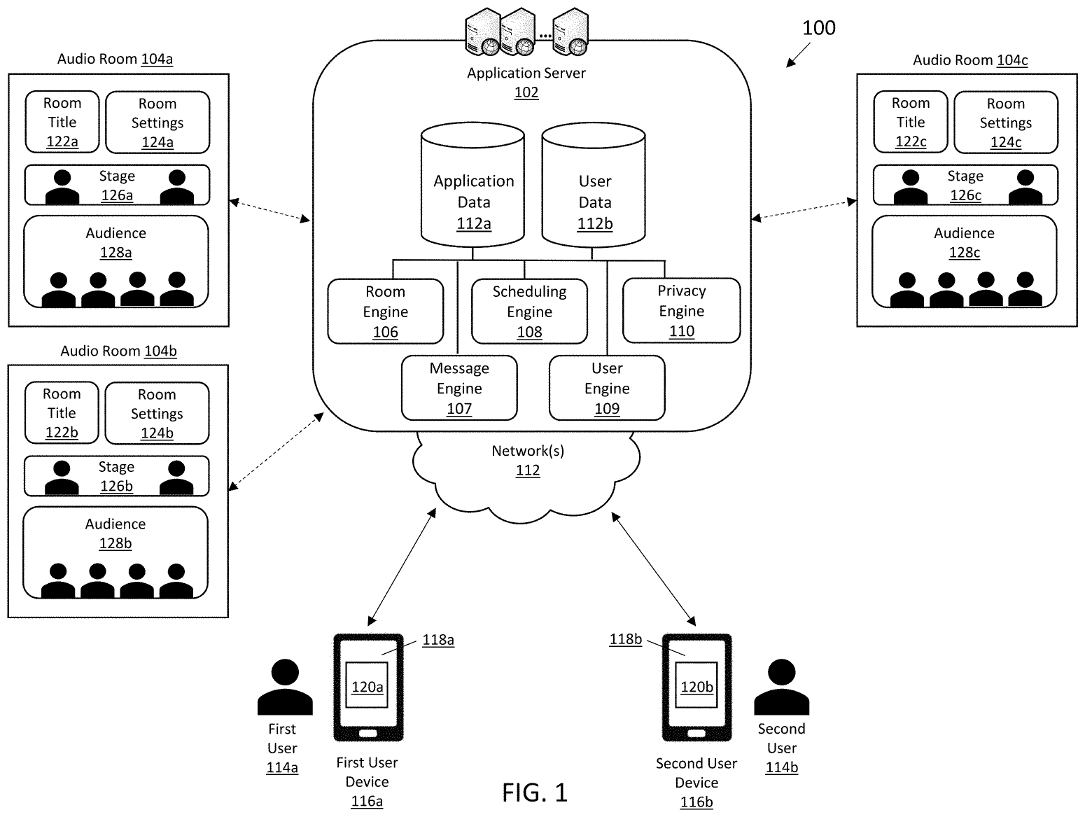

FIG. 1 is a block diagram of a system 100 for providing online audio discussion forums (i.e., rooms) in accordance with aspects described herein. In one example, the system 100 is implemented by an application server 102. The application server 102 provides functionality for creating and providing one or more audio rooms 104. The application server 102 comprises software components and databases that can be deployed at one or more data centers (not shown) in one or more geographic locations, for example. The application server 102 software components may include a room engine 106, a message engine 107, a scheduling engine 108, a user engine 109, and a privacy engine 110. The software components can comprise subcomponents that can execute on the same or on a different individual data processing apparatus. The application server 102 databases may include an application database 112 and a user database 114. The databases can reside in one or more physical storage systems. Example features of the software components and data processing apparatus will be further described below.

The application server 102 is configured to send and receive data (including audio) to and from users' client devices through one or more data communication networks 112 such as the Internet, for example. A first user 114a can access a user interface (e.g., user interface 120a) of a client application (e.g., client application 118a) such as a web browser or a special-purpose software application executing on the user's client device (e.g., first user device 116a) to access the one or more audio rooms 104 implemented by the application server 102. Likewise, a second user 114b can access a user interface (e.g., user interface 120b) of a client application (e.g., client application 118b) executing on the user's client device (e.g., second user device 116b). In one example, the user interfaces 120a, 120b and the client applications 118a, 118b are substantially the same. In some examples, the client applications 118a, 118b may provide or display user-specific content.

Although this application will describe many functions as being performed by application server 102, in various implementations, some or all functions performed by application server 102 may be performed locally by a client application (e.g., client applications 118a, 118b). The client application can communicate with the application server 102 over the network(s) 112 using Hypertext Transfer Protocol (HTTP), another standard protocol, or a proprietary protocol, for example. A client device (e.g., user devices 116a, 116b) can be a mobile phone, a smart watch, a tablet computer, a personal computer, a game console, or an in-car media system. Other types of client devices are possible.

In various implementations, the system 100 can enable online discussion between users in virtual audio forums (e.g., audio rooms 104). As shown, each of the audio rooms 104 can include a room title 122, room settings 124, a stage 126, and an audience 128. In one example, the title 122 corresponds to a pre-determined topic or subject of the discussion within each audio room 104. The users in each audio room 104 can be grouped as speakers or audience members (i.e., listeners). As such, the stage 126 may include one or more speakers (i.e., users with speaking privileges) and the audience 128 may include one or more audience members (i.e., users without speaking privileges).

In one example, users can navigate between various audio rooms as speakers and audience members via the client application 118. For example, the first user 114a may start a new audio room (e.g., 104a) as a speaker. In some examples, when starting the audio room 104a, the first user 114a may configure the room title 122a and the room settings 124a. The first user 114a may invite the second user 114 (or any other user) to join the first audio room 104a as a speaker or as an audience member. The second user 114 may accept the invitation to join the first audio room 104a, join a different audio room (e.g., 104b), or start a new audio room (e.g., 104c).

In one example, the room engine 106 of the application server 102 is configured to generate and/or modify the audio rooms 104. For example, the room engine 106 may establish the room title 122 and the room settings 124 based on user input provided via the client application 118 and/or user preferences saved in the user database 112b. In some examples, users can transition from speaker to audience member, or vice versa, within an audio room. As such, the room engine 106 may be configured to dynamically transfer speaking privileges between users during a live audio conversation. In certain examples, the audio rooms 104 may be launched by the room engine 106 and hosted on the application server 102; however, in other examples, the audio rooms 104 may be hosted on a different server (e.g., an audio room server).

The message engine 107 is configured to provide messaging functions such that users can communicate on the platform outside of audio rooms. In one example, the message engine 107 enables text-based messaging between users. The message engine 107 may be configured to support picture and/or video messages. In some examples, the message engine 107 allows users to communicate in user-to-user chat threads and group chat threads (e.g., between three or more users).

The scheduling engine 108 is configured to enable the scheduling of future audio rooms to be generated by the room engine 106. For example, the scheduling engine 108 may establish parameters for a future audio room (e.g., room title 122, room settings 124, etc.) based on user input provided via the client application 118. In some examples, the future audio room parameters may be stored in the application database 112a until the scheduled date/time of the future audio room. In other examples, the application database 112a may store the future audio room parameters until the room is started by the user via the client application 118.

The user engine 109 is configured to manage user relationships. For example, the user engine 109 can access the user database 112b to compile lists of a user's friends (or co-follows), external contacts, etc. In some examples, the user engine 109 can monitor and determine the status of a user. The user engine 109 may determine which users are online (e.g., actively using the platform) at any given time. In certain examples, the user engine 109 is configured to monitor the state of the client application 118 on the user device 116 (e.g., active, running in the background, etc.).

The privacy engine 110 is configured to establish the privacy (or visibility) settings of the audio rooms 104. The privacy settings of each audio room 104 may be included as part of the room settings 124. In one example, the privacy settings correspond to a visibility level of the audio room. For example, each audio room may have a visibility level (e.g., open, social, closed, etc.) that determines which users can join the audio room. In some examples, the visibility level of the audio room may change based on a speaker in the audio room, behavior in the audio room, etc. As such, the privacy engine 110 can be configured to dynamically adjust the visibility level of the audio room. In certain examples, the privacy engine 110 can suggest visibility level adjustments (or recommendations) to the speaker(s) in the audio room.

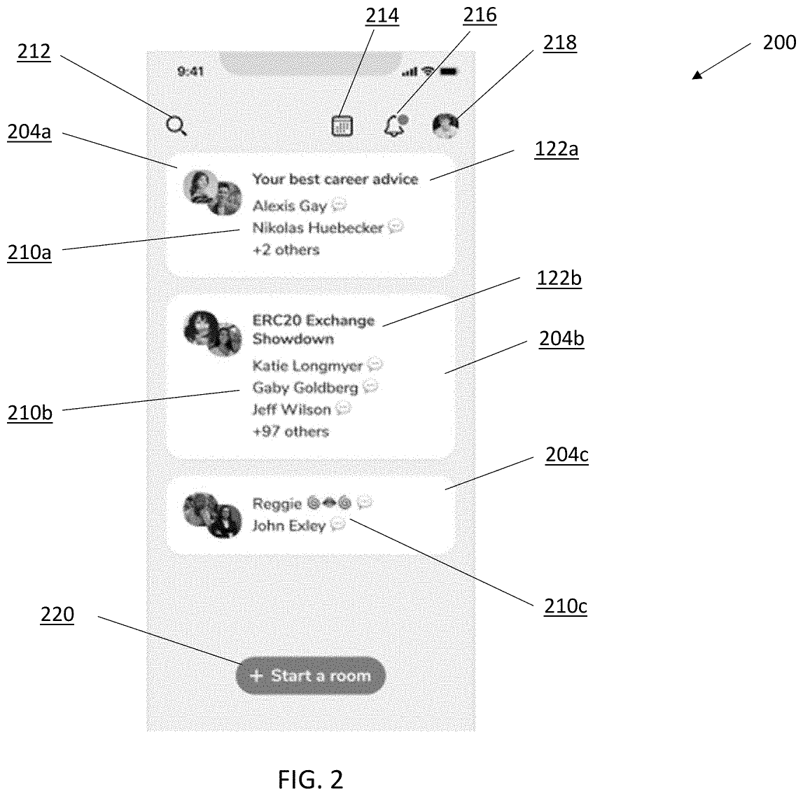

FIG. 2 is an example view 200 of the user interface 120 in accordance with aspects described herein. In one example, view 200 of the user interface 120 corresponds to a homepage of the client application 118. FIG. 2 and other figures presenting user interfaces in this application include icons and labels and refer to various features displayed by the user interface (e.g., search, schedule, notifications, etc.). While such icons and labels will be used to reference and describe such features in this application, the features may be presented with different icons and labels as well.

As shown, the user interface 120 can display live and/or upcoming audio rooms to the user. For example, home page 200 includes a first audio room tile 204a corresponding to the first audio room 104a having a title 122a named “Your best career advice,” a second audio room tile 204b corresponding to the second audio room 104b having a title 222b named “ERC20 Exchange Showdown,” and a third audio room tile 204c corresponding to the third audio room 104c. The audio rooms tiles 204 may be displayed in a scrollable list referred to as a “hallway.” In one example, the room engine 106 of the application server 102 is configured to select the audio rooms displayed to the user based on data from the application database 112a and/or the user database 112b. As shown, a list of users 210 associated with each audio room can be displayed in the audio room tiles 204 under the title of the audio room 122. In one example, the list of users 210 represents the current speakers in the audio room; however, in other examples, the list of users 210 may represent a different group of users (e.g., original speakers, all users, etc.). The user may join any of the audio rooms represented by the displayed audio room tiles 204 by selecting (e.g., tapping) on a desired audio room tile 204.

The user interface 120 may include icons representing various functions. For example, view 200 of the user interface 120 includes icons corresponding to an explore function 212, a calendar function 214, a notification function 216, a user profile function 218, and a new room function 220. In some examples, the functions are configured to be performed by various combinations of the system engine 106, the scheduling engine 108, and the privacy engine 110 of the application server 102.

In one example, the explore function 212 allows the user to search for different users and clubs. The explore function 212 may allow the user to search for other users by name (or username) and clubs by title (i.e., topic). For example, the user may use the explore function 212 to find clubs related to specific topics (e.g., finance, TV shows, etc.). Likewise, the user may use the explore function 212 to view the clubs that specific users are members of. In some examples, the explore function 212 may be performed, at least in part, by the room engine 106 of the application server 102.

The calendar function 214 is configured to display upcoming audio rooms associated with the user. In one example, the calendar function 214 may display upcoming audio rooms where the user is a speaker and/or audio rooms that the user has indicated interest in attending. For example, the calendar function 214 may display upcoming audio rooms where at least one speaker is followed by the user and audio rooms associated with clubs that the user is a member of In some examples, the calendar function 214 is performed, at least in part, by the scheduling engine 108 of the application server 102. Likewise, the notification function 216 is configured to notify the user of user-specific notifications. For example, the notification function 216 may notify the user of an event (e.g., upcoming audio room), the status of a user follow request, etc.

In some examples, the user profile function 218 allows the user to view or update user-specific settings (e.g., privacy preferences). Likewise, the user profile function 218 allows the user to add/modify user parameters stored in the user database 112b. In some examples, the user profile function 218 may provide the user with an overview of their own social network. For example, the user profile function 218 can display other users who follow the user, and vice versa. The user profile function 218 may be performed, at least in part, by the privacy engine 110 of the application server 102.

In one example, the new room function 220 allows the user to start a new audio room. In some examples, the new room function 220 may be performed by the room engine 106 and/or the scheduling engine 108.

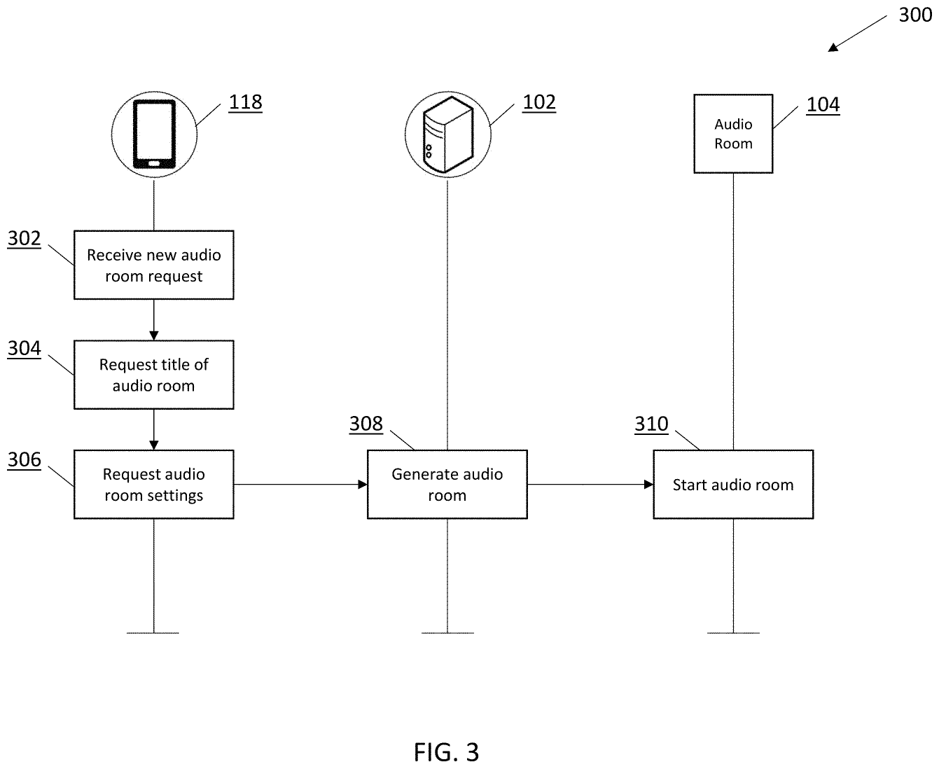

FIG. 3 is a flow diagram of a method 300 for starting an audio room in accordance with aspects described herein. In one example, the method 300 includes assigning a title to the audio room (e.g., room title 122). In some examples, the method 300 corresponds to a process carried out by the application server 102 and the client application 118.

At step 302, the client application 118 receives a request to start a new audio room 104. In one example, the user may request a new audio room via the user interface 120 of the client application 118. For example, the user may request a new audio room 104 by selecting (e.g., tapping) a button within the user interface 120 corresponding to the new room function 220, as shown in FIG. 2.

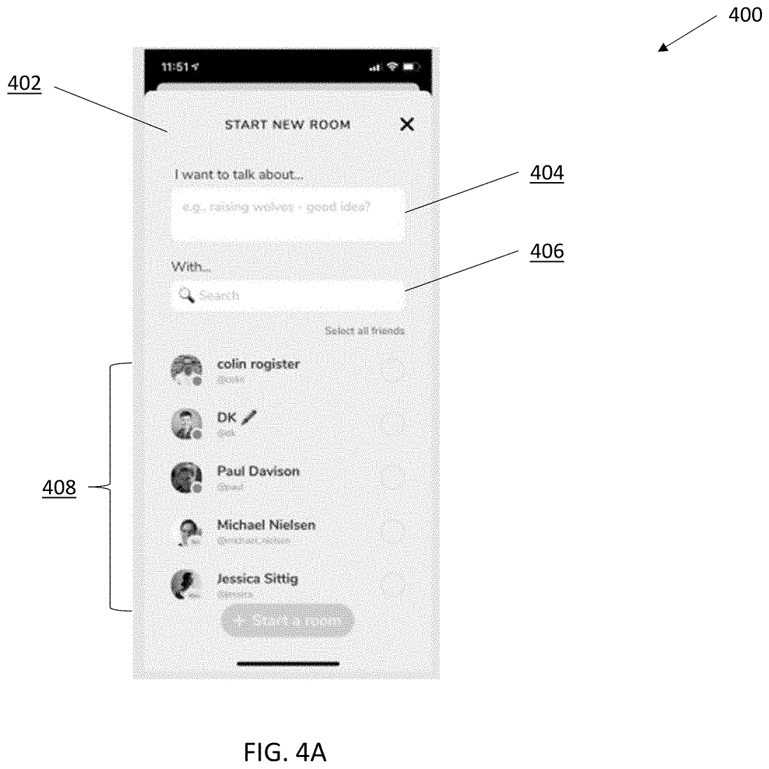

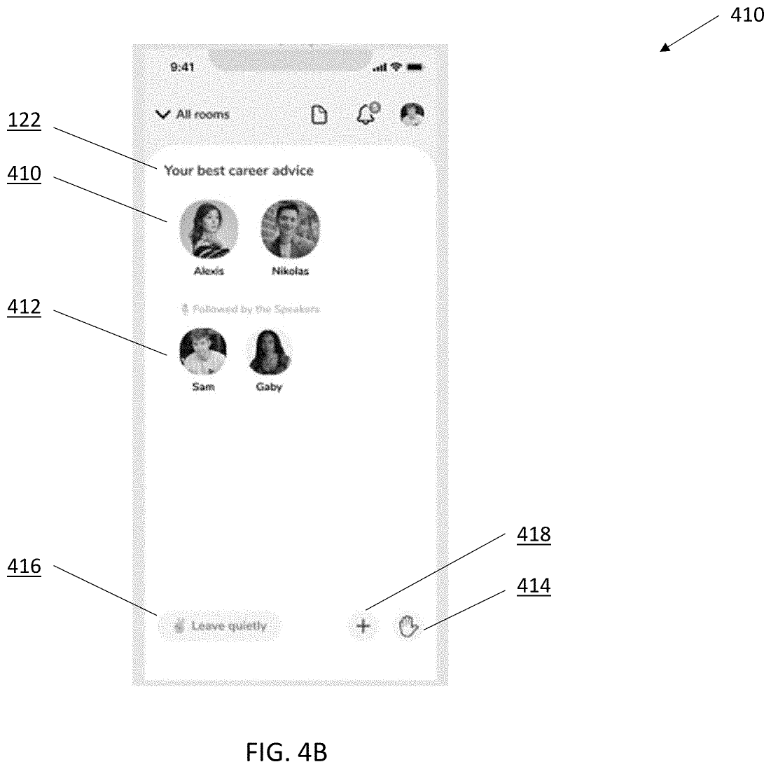

At step 304, the client application 118 is configured to request a room title 122 for the audio room 104. In one example, the user interface 120 displays a tab (or window) for the user 114 to enter a desired room title 122. For example, FIG. 4A is an example view 400 of the user interface 120 having a new room tab 402. As shown, the new room tab 402 includes an entry box 404 for the user to enter the room title 122. The room title 122 corresponds to a topic or subject that the user intends to talk about (e.g., “Your best career advice”). In some examples, the room title 122 may correspond to an event (e.g., holiday, birthday, etc.). In certain examples, the room title 122 may be the name of person or include the name of a person (e.g., “Happy Birthday John”). The room title 122 may include various combinations of letters, numbers, and/or images (e.g., emojis).

At step 306, the client application 118 is configured to request parameters for the audio room 104. In one example, the room parameters include users to be invited as speakers or audience members. For example, as shown in FIG. 4A, the new room tab 402 includes a search box 406. The user may use the search box 406 to find other users to invite to the audio room 104. In some examples, the new room tab 402 includes a scrollable list 408 of the user's friends, or a portion of the user's friends (e.g., top friends). In this context, “friend” corresponds to a second user who follows a first user and/or is followed by the first user (i.e., co-followed). As such, the user may use the search box 406 and/or the scrollable list 408 to find/select users to be invited to the audio room 114. While not shown, the new room tab 402 may include additional room settings (e.g., privacy or visibility levels).

At step 308, the application server 102 is configured to generate the audio room 104. The application server 102 receives the audio room information (e.g., title and parameters) from the client application 118. In one example, the room engine 106 of the application server 102 is configured to generate an audio room instance based on the received audio room information. In some examples, the room engine 106 sends notifications to the users who are being invited to the join the audio room 104 as speakers and/or audience members. At step 310, the application server 102 starts the audio room 104. In one example, the room engine 106 is configured to start the audio room 104 by launching the generated audio room instance on the application server 102 (or a different server). In some examples, once started, the audio room 104 may become visible to other users. For example, the title 122 of the audio room 104 may become visible to users who follow the speaker(s) of the audio room via the calendar function 214 (shown in FIG. 2). As such, these users may discover and join the audio room 104. Likewise, once started, the audio room 104 may be made visible to friends of the user 114. For example, the audio room 104 may appear on the homepages (e.g., view 200 of FIG. 2) of other users who are friends with the user.

FIG. 4B is an example view 410 of the user interface 120. In one example, the view 410 corresponds to the live audio room 104 from the perspective of an audience member. As shown, the room title 122 is displayed along with a speaker list 410. The speaker list 410 indicates the current speakers in the audio room 114. In some examples, an audience list 412 is displayed indicating the audience members who are followed by (or friends with) the speaker(s). In other examples, the audience list 412 may include all audience members (i.e., including those not followed by the speakers). A speaker request button 414 is included allowing audience members to request speaking privileges. For example, audience members may be transitioned from the audience 128 to the stage 126 at the discretion of at least one speaker (e.g., a moderator). An exit button 416 is included allowing users to leave the audio room 104. It should be appreciated that all users (speakers and audience members) may leave the audio room 104 at any time. In some examples, the speakers (including the original speaker(s)) can leave the audio room 104 without ending or stopping the audio room 104.

In some examples, assigning a title to the audio room 104 can improve the likelihood of the audio room 104 being successful. For example, by assigning a title to the audio room 104, users may decide if they are interested in participating in the discussion before joining the audio room. As such, users may find and join audio rooms of interest, leading to larger audiences, new speakers, and longer, high-quality discussions.

As shown in FIG. 4B, the user interface 120 includes a ping user button 418. The user (e.g., speaker or audience member) can select the ping user button 418 to invite or “ping” users to join the audio room 104.

### Pinging Users Into Audio Rooms

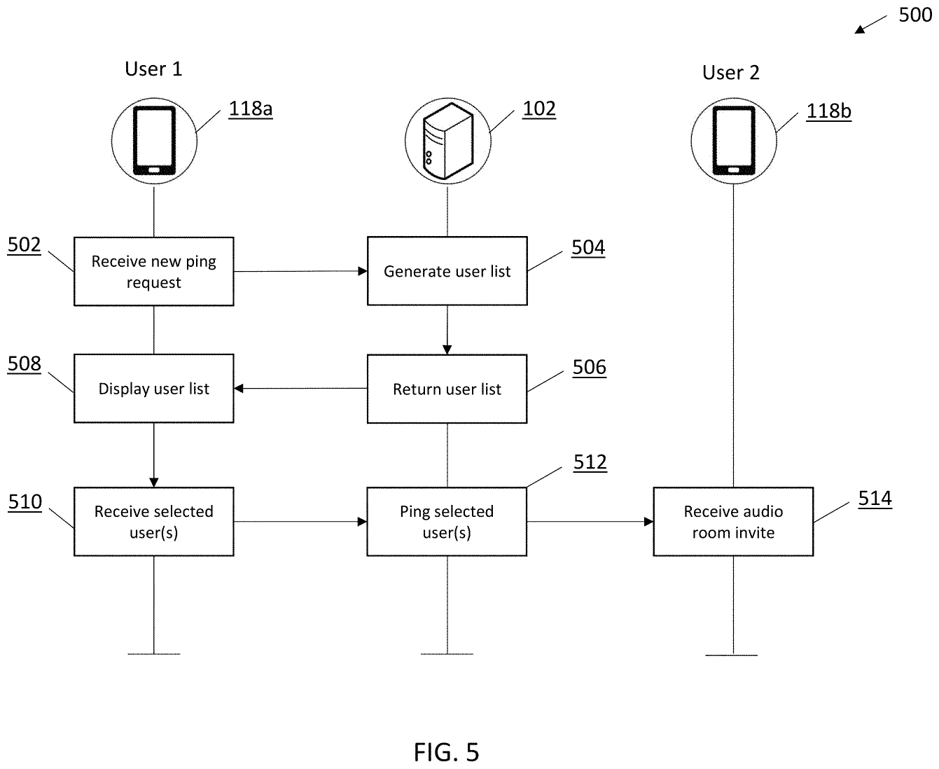

FIG. 5 is a flow diagram of a method 500 for pinging users into an audio room in accordance with aspects described herein. In one example, the method 500 includes pinging users into an audio room based on the speaker(s). In some examples, the method 500 corresponds to a process carried out by the application server 102 and the client application 118.

At step 502, the client application 118a receives a new ping request from the first user 114a in the audio room 104. In one example, the first user 114a is a speaker in the audio room 104. The first user 114a may request to ping one or more users via the user interface 120a of the client application 118a. For example, the first user 114a may request to ping one or more users by selecting (e.g., tapping) a button within the user interface 120a (e.g., ping user button 418 of FIG. 4B).

At step 504, the application server 102 is configured to generate a user list corresponding to the received ping request. The application server 102 receives information corresponding to the first user 114a and the audio room 104 from the client application 118a. In one example, the user engine 109 of the application server 102 is configured to generate the user list based on the received user and audio room information. For example, the user engine 109 can compile a list of users who co-follow the speaker(s) in the audio room 104. If there are two or more speakers in the audio room 104, the user engine 109 may filter the list of co-followed users down to a list of users who are co-followed by at least two of the speakers. In some examples, the user engine 109 is configured to sort the list of co-followed users based on priority. For example, users who are co-followed by three speakers may appear higher in the list than users who are co-followed by two speakers, and so on. In one example, the sorted list of co-followed users is saved by the room engine 106 as a User Set A.

In some examples, the user engine 109 is configured to prepend the speakers in the audio room 104 to User Set A, and to save the modified User Set A as a new User Set B. In certain examples, the number of speakers saved to User Set B is capped at a certain threshold (e.g., first 20 speakers). The user engine 109 can compile a list of contacts of the users included in User Set B. For example, the contacts may be based on information provided by the user (e.g., contact list) and/or information sourced from another database, such as an external social network. In this context, “contacts” refers to both individuals who have user accounts on the platform and those that do not. In some examples, the user engine 109 is configured to sort the list of contacts based on priority. For example, contacts who are shared between three users included in User Set B may appear higher in the list than contacts who are shared between two users included in User Set B, and so on. In one example, the sorted list of contacts is saved by the room engine 106 as User Set C.

The user engine 109 can filter User Sets A, B, and C based on information corresponding to the first user 114a. For example, the user engine 109 may filter User Set A such that only users the first user 114a has permission to ping are included (e.g., users that co-follow the first user 114a). In certain examples, the number of users included in User Set A is capped at a certain threshold (e.g., top 8 users), and the user engine 109 may remove any users from User Set A that exceed the threshold. In one example, this filtered User Set A represents a “mutual user set” for the first user 114a. Likewise, the user engine 109 may filter User Set B such that only contacts associated with the first user 114a are included (e.g., from the user's own contact list). This filtered User Set B represents a “external user set” for the first user 114a. In some examples, the user engine 109 is configured to remove any online (e.g., currently active) users from the mutual user set (i.e., filtered User Set A) and the external user set (i.e., filtered User Set B). The online users can be saved in a new “online user set” for the first user 114a. In one example, the user engine 109 is configured to combine the user sets into an master user list. For example, the master user list may include the users sets in the order of: mutual user set, external user set, and online user set.

At step 506, the user engine 109 of the application server 102 is configured to return the user list corresponding to the first user 114a and the audio room 104 to the client application 118a. In one example, the user engine 109 is configured to return the ordered master user list; however, in other examples, the user engine 109 may return a different user list (e.g., the mutual user set, the external user set, etc.).

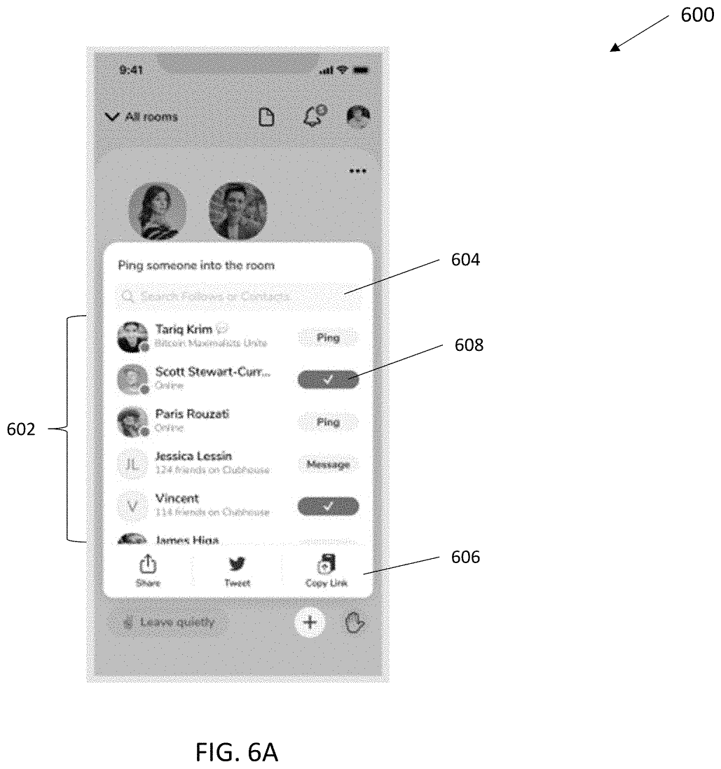

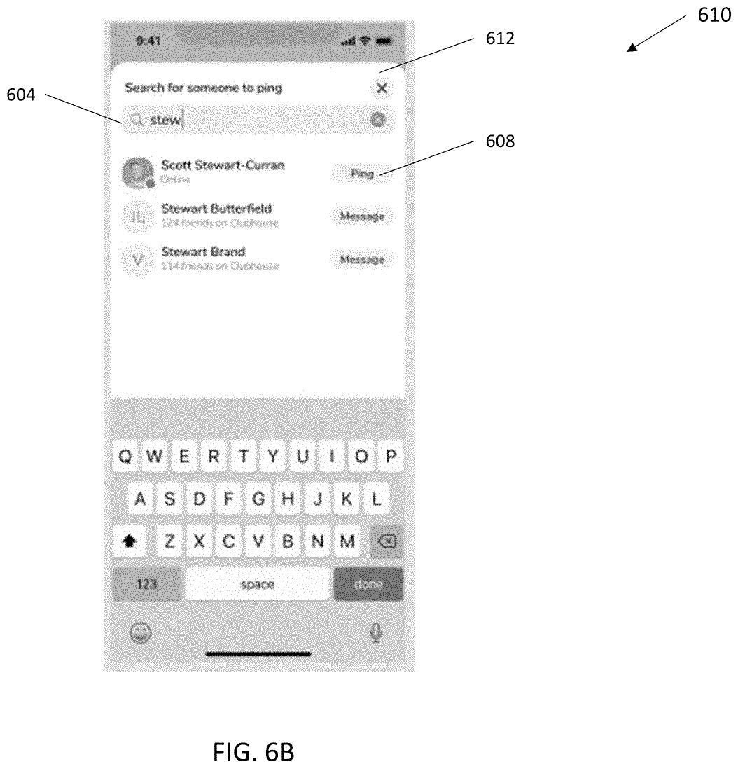

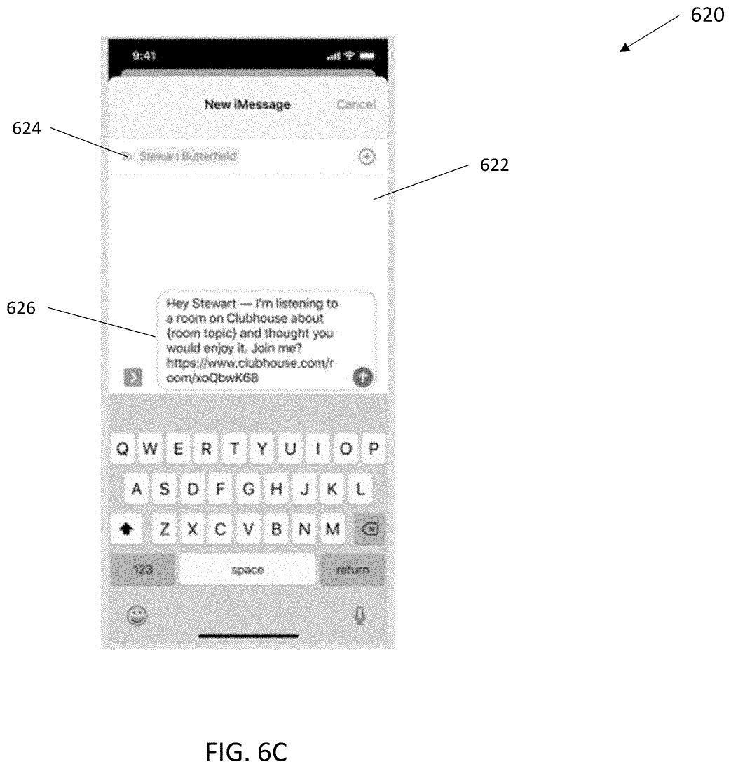

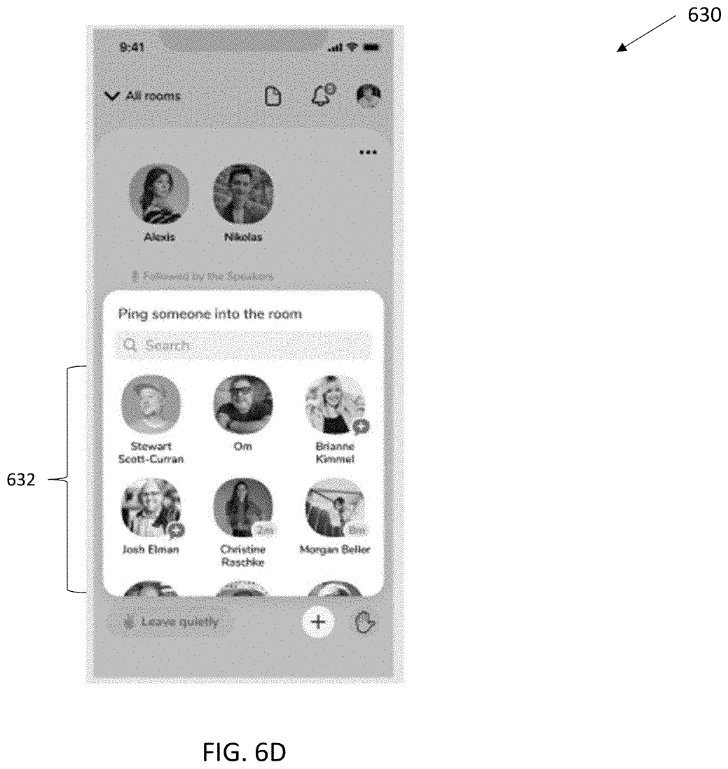

At step 508, the client application 118a is configured to receive and display the user list. FIG. 6A is an example view 600 of the user interface 120a. In one example, the view 600 corresponds to the view presented to the first user 114a after selecting the ping user button 418 of FIG. 4B. As shown, the user interface 120a provides a scrollable user list 602, a search box 604, a share bar 606, and a plurality of ping buttons 608. In some examples, the user list 602 corresponds to the ordered master user list received from the application server 102. For example, the users in the user list 602 may be ordered such that users from the mutual user set are displayed at the top of the list, users from the external user set are displayed in the middle of the list, and users from the online user set are displayed at the bottom of the list. The first user 114a may also search for users via the search box 604. In one example, the search box 604 enables the first user 114a to search the users included in the user list 602; however, in other examples, the search box 604 may enable the user to search all users, such as users and contacts not included in the user list 602. The share bar 606 allows the first user 114a to generate a link to the audio room 104 and to share the audio room link via other external platforms (e.g., social media platforms).

At step 510, the client application 118a receives at least one user that the first user 114a has selected to ping. As described above, the first user 114a can browse users to ping by scrolling through the user list 602 or searching for users via the search box 604. In some examples, a separate search tab is displayed to the first user 114a when using the search function. For example, FIG. 6B illustrates an example view 610 of the user interface 120a including a search tab 612. As shown, the first user 114a may search for users via the search box 604 and results may appear below in real-time as the user is typing. A corresponding ping button 608 is displayed next to each user that appears in the search results.

In one example, the first user 114a can select users to ping by selecting (or tapping) the ping button 608 next to each user. In some examples, the ping button 608 may have a specific configuration depending on the type of user (e.g., platform user, external contact, etc.). For example, for users that have user accounts on the platform, the ping button 608 may default to display “Ping” and may change to display a check mark when selected. Likewise, for external users that do not have user accounts on the platform, the ping button 608 may default to display “Message.”

In some examples, when a ping button 608 displaying “Message” is selected, a separate messaging tab is displayed to the first user 114a. For example, FIG. 6C illustrates an example view 620 of the user interface 120a including a messaging tab 622. As shown, the messaging tab 622 includes contact information 624 and a message 626 corresponding to the selected user. For example, the contact information 624 includes a phone number (or email) of the selected user and the message 626 is personalized for the selected user (e.g., “Hey Stewart”). The contact information 624 and the message 626 may be auto-generated (or auto-filled) by the client application 118a. The message 626 can include a description of the audio room 104 (e.g., room title) and a link to join the audio room 104. In certain examples, the link to join the audio room 104 is a web link that directs the selected user to the audio room 104. In some examples, the link may automatically open the client application 118 on a device of the selected user or direct the selected user to an application store to download the client application 118. As such, the messaging tab 622 allows the first user 114 to ping external users to join the audio room 104 without leaving the client application 118a. In some examples, when pinging multiple external contacts, a group message can be sent to the external contacts in a group message thread. In certain examples, the messaging tab 622 is configured to leverage features and/or functionality from a native messaging application installed on the client device 116a (e.g., Apple iMessage).

At step 512, the room engine 106 of the application server 102 is configured to receive the user(s) selected by the first user 114a to ping. In one example, the room engine 106 only receives the selected users who have accounts on the platform, as the external users are “pinged” via the messaging function (e.g., messaging tab 622) of the client application 118a. In some examples, the room engine 106 is configured to send an audio room invite (or notification) to the selected users to join the audio room 104. For example, the room engine 106 may send an invite to the second user 114b.

At step 514, the client application 118b corresponding to the second user 114b is configured to receive the audio room invite from the room engine 106. In one example, the client application 118b can display the invite as a notification with the user interface 120b (e.g., a pop-up notification). In other examples, the client application 118b can provide the invite as a message in a messaging function of the user interface 120b. As described above, some users (e.g., external users) may receive an audio room invite as a text message (or email) outside of the client application 118.

While the above example describes users being displayed in a list (e.g., user list 602), in other examples the users can be displayed differently. For example, FIG. 6D illustrates an example view 630 of the user interface 120. In one example, the view 630 is substantially similar to the view 600 of FIG. 6A, except the view 630 includes users displayed in a user grid 632. In some examples, the users in the user grid 632 can be displayed in a specific order (similar to the user list 602). For example, the users in the user grid 632 can be displayed based on the ordered master user list received from the application server 102.

### Starting Audio Rooms From Chat Threads

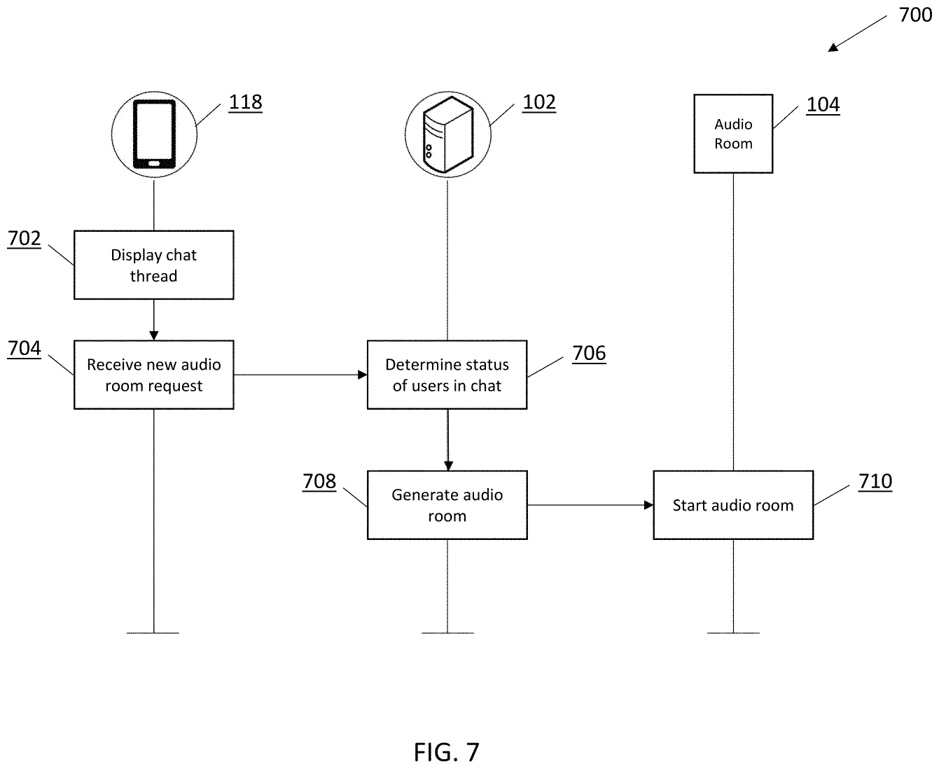

FIG. 7 is a flow diagram of a method 700 for starting an audio room from a chat thread in accordance with aspects described herein. In one example, the method 500 corresponds to a process carried out by the application server 102 and the client application 118. In various embodiments, the chat thread can be any known or future chat thread system, e.g., those made available by third party platforms such as, as a few examples, a Twitter direct message (“DM”) thread, a Facebook Messenger message, a Slack message, etc.

At step 702, the client application 118 is configured to display a chat thread to the user 114. The chat thread corresponds to a text-based conversation between two or more users. In some examples, the chat thread can include picture, images, and videos. In one example, the chat thread is part of a messaging function provided by the message engine 107 of the application server 102 and the user interface 120 of the client application 118 that allows users to communicate outside of audio rooms.

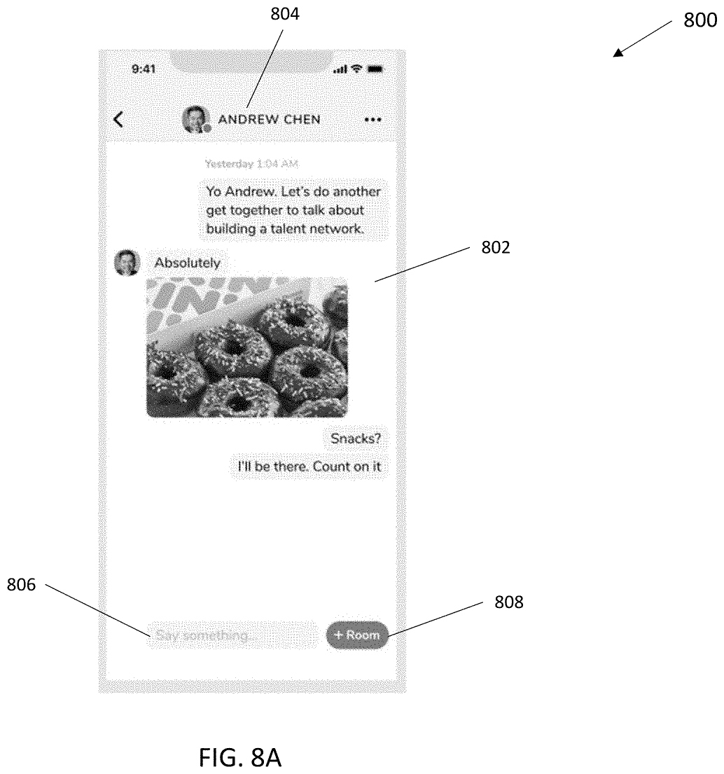

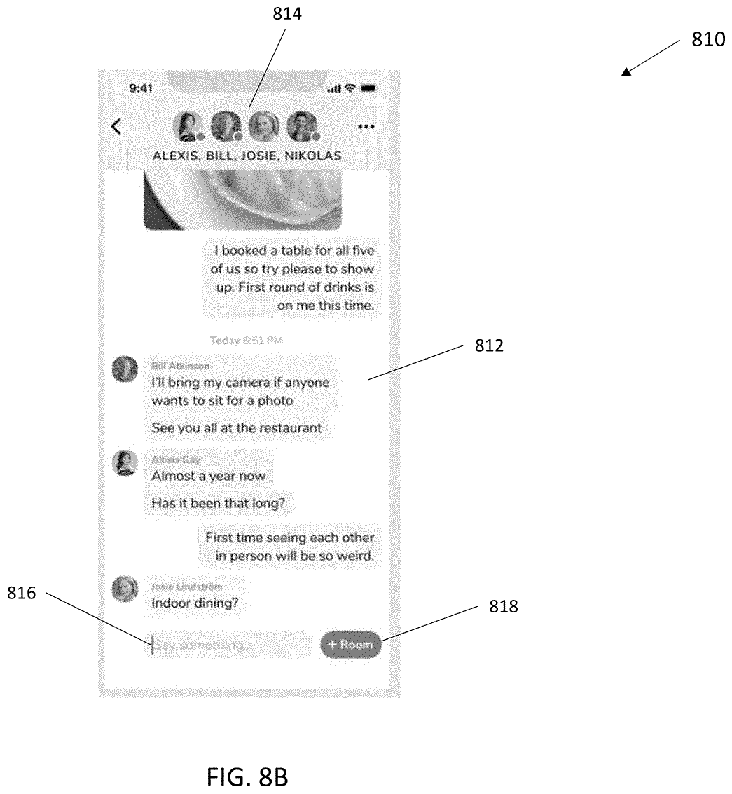

FIG. 8A is an example view 800 of the user interface 120. In one example, the view 800 corresponds to a chat thread 802 from the perspective of the user 114. As shown, the user interface 120 is configured to display a user name 804, a message entry box 806, and an audio room button 808. In one example, the user name 804 corresponds to the user that the user 114 is conversing with. The message entry box 806 is provided for the user 114 to enter messages in the chat thread 802.

At step 704, the client application 118 receives a request to start a new audio room 104 from the chat thread 802. The user 114 may request a new audio room by selecting (e.g., tapping) the audio room button 808 within the chat thread 802. In one example, the audio room button 808 corresponds to the new room function 220 of FIG. 2.

At step 706, the user engine 109 of the application server 102 is configured to determine a status of the users in the chat thread 802. For example, the user engine 109 may check if each user is currently online (or actively using the platform). If at least one user is offline (or inactive), the room engine 106 may send a notification or alert to the offline user(s) that an audio room has been requested. In certain examples, the room engine 106 may wait until each user is online before generating the audio room 104.

At step 708, the room engine 106 of the application server 102 is configured to generate the audio room 104. In one example, the room engine 106 is configured to generate an audio room instance based on parameters of the chat thread 802. For example, the audio room 104 may have a room title 122 corresponding to the names of the user in the chat thread (e.g., “Chat between John and Mike”). In some examples, the audio room 104 is generated as a private (or closed) room including only the members of the chat thread 802. Likewise, each member of the chat thread 802 can be added to the audio room 104 as a speaker. In some examples, the room engine 106 sends notifications to the users who are being invited to the join the audio room 104 as speakers.

At step 710, the application server 102 starts the audio room 104. In one example, the room engine 106 is configured to start the audio room 104 by launching the generated audio room instance on the application server 102 (or a different server). In some examples, once started, the audio room 104 may become visible to all users included in the chat tread 802. For example, the title 122 of the audio room 104 may become visible to each user via the calendar function 214 (shown in FIG. 2). As such, each member of the chat thread 802 may discover and join the audio room 104. Once started, the audio room 104 can be opened up by the user 114 (or another chat member) and made visible to friends of the user 114 (or other chat members).

While the example above describes a chat between two users, it should be appreciated that an audio room can be started from a group chat thread (e.g., group message). FIG. 8B is an example view 810 of the user interface 120. In one example, the view 810 corresponds to a group chat thread 812 from the perspective of the user 114. As shown, the user interface 120 is configured to display the user names 814, a message entry box 816, and an audio room button 818. In one example, the user names 804 correspond to each user that the user 114 is conversing with (e.g., each member of the group chat). In some examples, the user names 804 may be displayed as a group name (e.g., club name) rather than the individual names of each user. The message entry box 816 is provided for the user 114 to enter messages in the group chat thread 812. The user 114 may request a new audio room by selecting (e.g., tapping) the audio room button 818 within the chat thread 812. In one example, each member of the group chat thread 812 can be added to the audio room 104 as a speaker; however, in some examples, at least a portion of the group chat members can be added to the audio room as audience members. In certain examples, the room engine 106 sends notifications to the members of the group chat who are being invited to the join the audio room 104. In some examples, the user 114 can request to start an audio room 104 with only a portion of the members of the groups chat thread 812 (e.g., one other member, two other members, etc.).

### Waving at Users to Start Audio Rooms

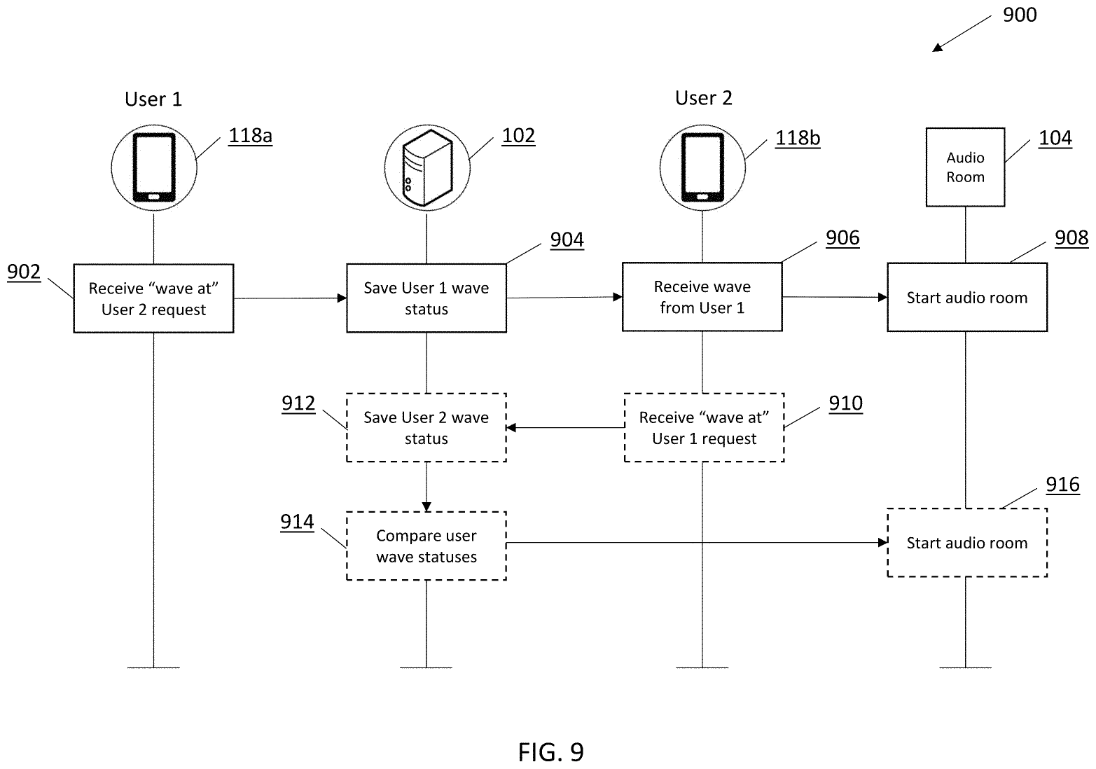

FIG. 9 is a flow diagram of a method 900 for waving at users to start an audio room in accordance with aspects described herein. In this context, a first user can “wave at” a second user to indicate that they are interested in talking with the second user in an audio room. In one example, the method 500 corresponds to a process carried out by the application server 102 and the client application 118.

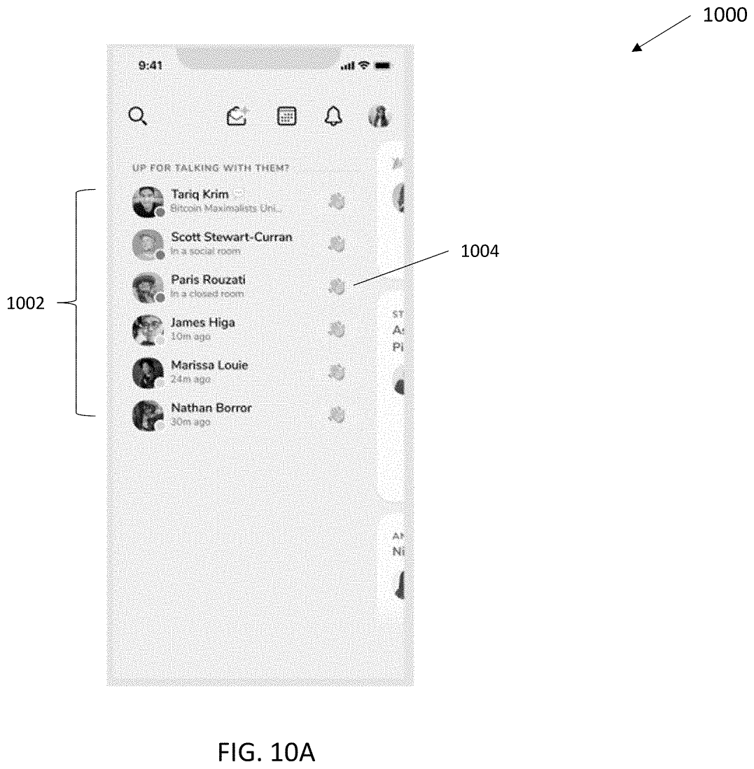

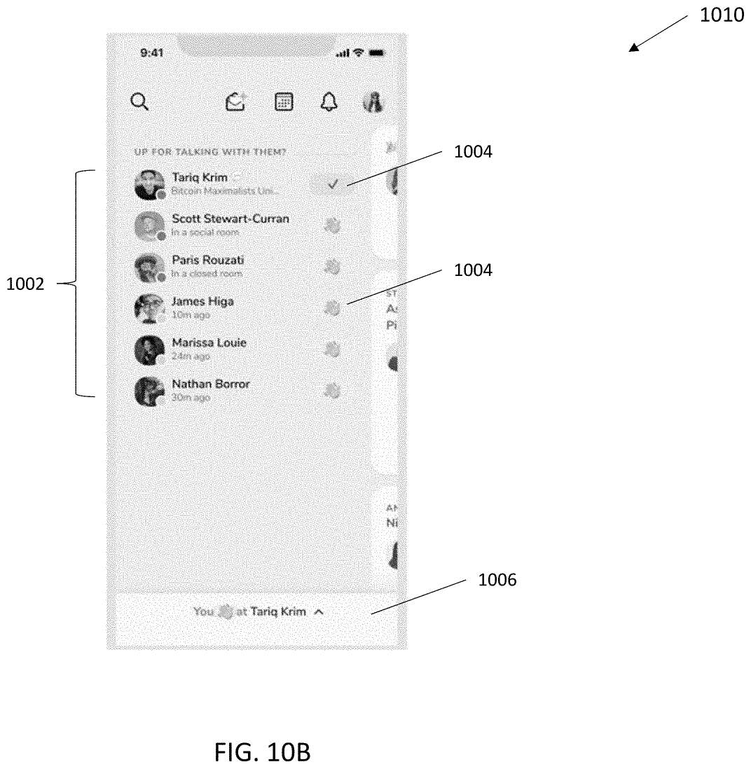

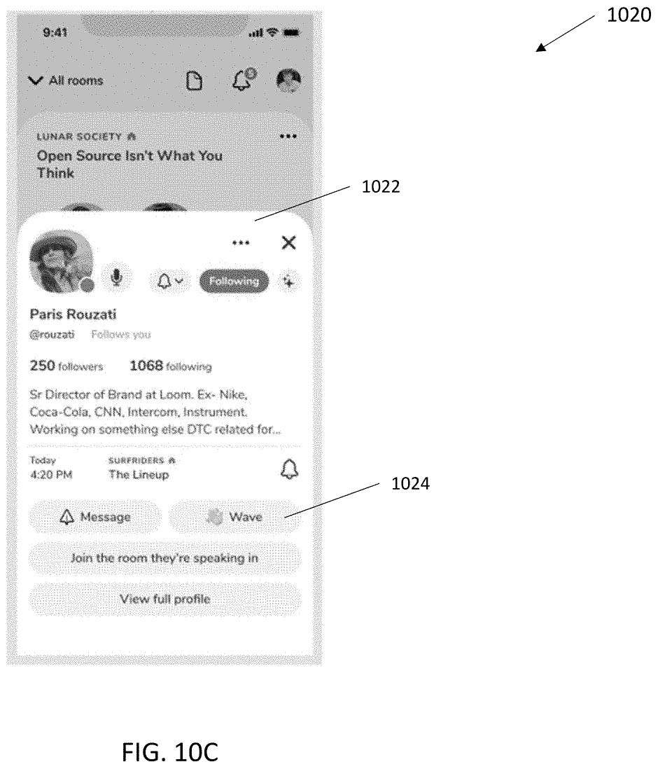

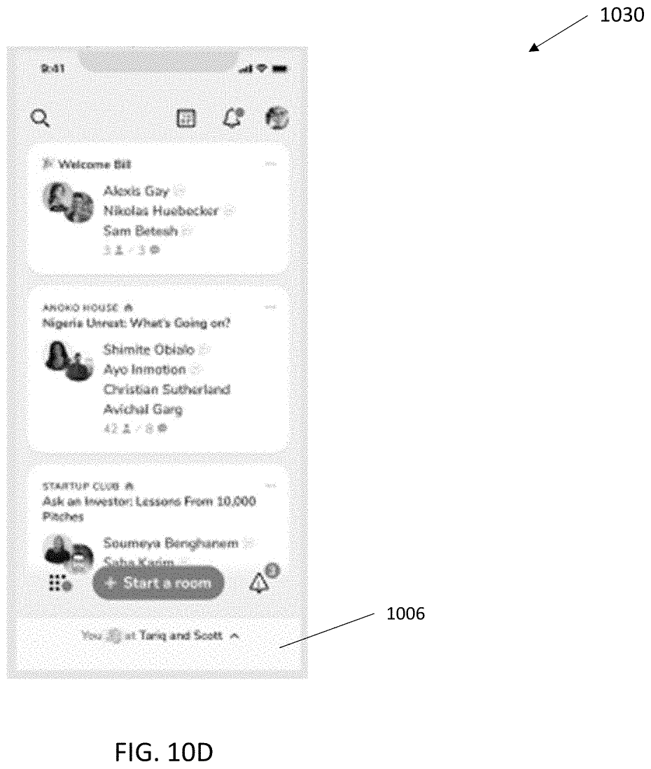

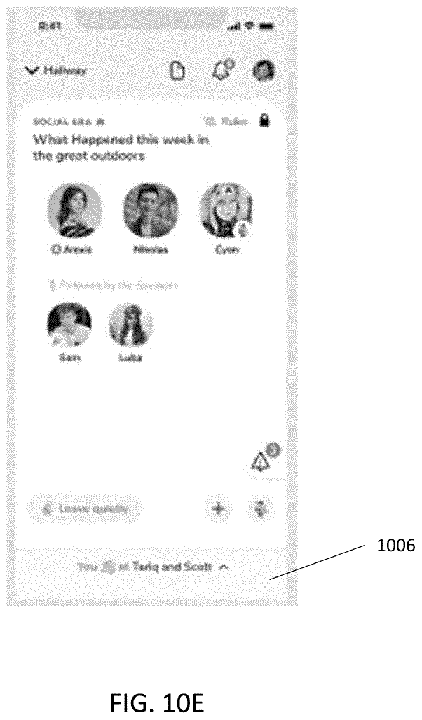

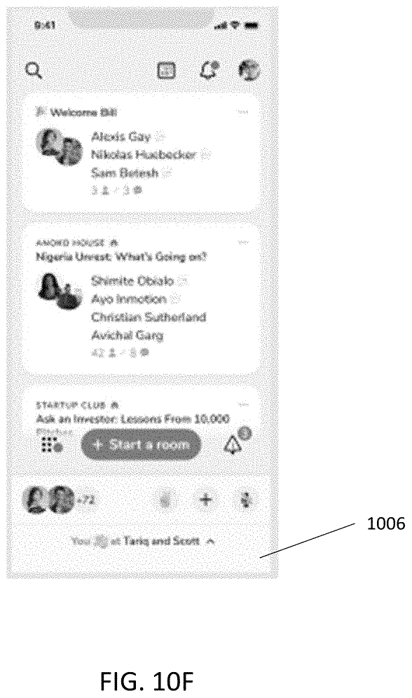

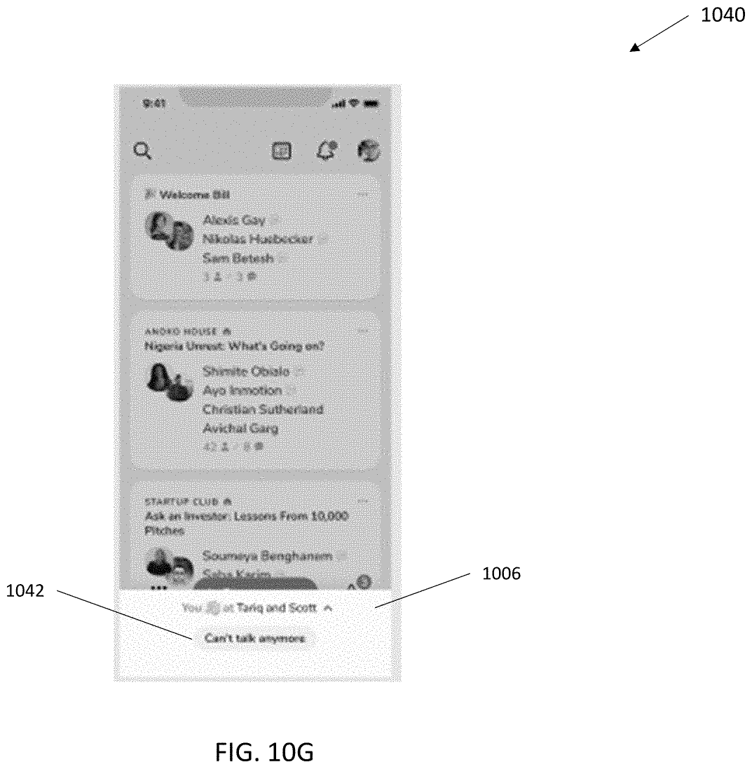

At step 902, the client application 118a receives a “wave at” request from the first user 114a. In one example, the first user 114a may “wave at” one or more users via the user interface 120a of the client application 118a. For example, FIG. 10A illustrates an example view 1000 of the user interface 120a. In one example, the first user 114a can navigate to the view 1000 by swiping in a specific direction (e.g., left) on the home screen of the user interface 120a (e.g., view 200 of FIG. 2). As shown, a user list 1002 is displayed to the first user 114a. In one example, the user list 1002 includes users who follow the first user 114a. In some examples, the users included in the user list 1002 correspond to the first user's friends (or co-follows) who are currently online. In other examples, the users included in the user list 1002 may correspond to a different group of users, such as the various user sets described above (e.g., User Set A, User Set B, etc.).

In one example, each user in the user list 1002 has a corresponding wave button 1004. The first user 114a may request to “wave at” or more users by selecting (e.g., tapping) the wave button 1004 next to the user(s) in the user list 1002. For example, FIG. 10B illustrates an example view 1010 of the user interface 120a. As shown, the wave button 608 may default to display a hand wave icon and can change to display a check mark when selected. The selected user(s) can be added to a wave bar 1006 indicating that the first user 114a has waved at another user (e.g., the second user 114b).

In some examples, the first user 114a can request to “wave at” at users who follow them via the user's profile. FIG. 10C illustrates an example view 1020 of the user interface 120a including a user profile tab 1022. In one example, the user profile tab 1022 is displayed when the first user 114a selects another user within the user interface 120a (e.g., from the home screen, in a chat thread, etc.). Likewise, the user profile tab 1022 may be displayed to the first user 114a when searching users via the explore function 212 (shown in FIG. 2). As shown, the user profile tab 1022 includes a wave button 1024. The first user 114a may request to “wave at” the user by selecting (e.g., tapping) the wave button 1024. In some examples, once “waved at,” the user is added to the wave bar 1006 displayed to the first user 114a.

At step 904, the application server 102 is configured to receive the user(s) “waved at” by the first user 114a. In one example, the user engine 109 of the application server 102 is configured to save a wave status of the first user 114a corresponding to the user(s) selected by the first user 114a to “wave at” (e.g., the second user 114b). In some examples, the user engine 109 can save the wave status of the first user 114a in the user database 112b. In certain examples, the user engine 109 is configured to send a wave notification (or alert) to the selected users on behalf of the first user 114a. For example, the user engine 109 may send a wave notification to the second user 114b.

At step 906, the client application 118b corresponding to the second user 114b is configured to receive the wave notification from the user engine 109. In one example, the client application 118b can display the notification as an alert within the user interface 120b (e.g., a pop-up alert). For example, the client application 118b may display the notification at the top of the user interface 120 as a banner (e.g., a toast). In other examples, the client application 118b can provide the wave notification as a message in a messaging function of the user interface 120b. In some examples, the second user 114b can accept the wave notification (e.g., “wave back”) to start an audio room 104.

At step 908, in response to the second user 114b accepting the wave notification from the first user 114a, the room engine 106 is configured to generate an audio room 104. In one example, the room engine 106 is configured to generate an audio room instance corresponding to the first user 114a and the second user 114b. For example, the audio room 104 may have a room title 122 corresponding to the names of the users 114a, 114b (e.g., “Chat between John and Mike”). In some examples, the audio room 104 is generated as a private (or closed) room including only the first and second users 114a, 114b. Likewise, each user 114a, 144b can be added to the audio room 104 as a speaker. The room engine 106 may start the audio room 104 by launching the generated audio room instance on the application server 102 (or a different server). Once started, the audio room 104 may be opened up by the first user 114a (or the second user 114b) and made visible to friends of the first user 114a and/or the second user 114b.

In one example, room invites can be sent to users that the first user 114a or the second user 114b “waved at” before joining the audio room 104. For example, if the first user 114a waved at ten users (including the second user 114b), than the remaining nine “waved at” users may receive invites to join the audio room 104. The users who receive room invites may join the audio room 104 as speakers, audience members, or as a combination of both at the discretion of the first user 114a and/or the second user 114b. In some examples, the room invites may remain active as long as the audio room 104 is active (e.g., open); however, in other examples, the room invites may expire after a predetermined amount of time (e.g., ten minutes). In certain examples, the room invites may expire after a conditional event. For example, if the first user 114a leaves the audio room 104, the room invites sent to the users who were waved at by the first user 114a may expire (or be rescinded). The first user 114a and/or the second user 114b may rescind the room invites sent to the other “waved at” users at any time via the client application 118.

In some examples, if the wave notification is not acknowledged (or accepted) by the second user 114a, the first user 114a may continue to use the client application 118a as normal. In certain examples, the room engine 106 may save the wave status of the first user 114a (step 904) without sending a wave notification to the second user 114b to launch an audio room (steps 906, 908). In such examples, after waving at the second user 114b, the first user 114a may continue to use the client application 118a as normal.

FIG. 10D illustrates an example view 1030 of the user interface 120a including a wave bar 1006. In one example, the view 1030 corresponds to the home screen of the user interface 120a including the wave bar 1006. The first user 114a can continue use the platform (e.g., browse audio rooms, search users, etc.) while maintaining active waves in the wave bar 1006. In some examples, the first user 114a can join an audio room as audience member while maintaining active waves in the wave bar 1006 (see FIG. 10E). Likewise, the first user 114a may return to the home screen while remaining in the audio room and maintaining active waves in the wave bar 1006 (see FIG. 10F). At any point, the first user 114a may dismiss (or cancel) their active waves. For example, FIG. 10G illustrates an example view 1040 of the user interface 120a including the wave bar 1006. As shown, the first user 114a may select (or tap) on the wave bar 1006 to display a “Can't talk anymore” button 1042. The user 114a can select (or tap) the button 1042 to dismiss (or cancel) any active waves previously selected. In some examples, in response to the first user 114a dismissing (or canceling) any active waves, the client application 118a can send a request to the user engine 109 of the application server 102 to clear (or update) the wave status of the first user 114a in the user database 112b. In some examples, the first user 114a can continue to use the platform as normal until a wave match is found.

At step 910, the client application 118b receives a “wave at” request from the second user 114b. In one example, the first user 114a can “wave at” one or more users via the user interface 120b of the client application 118b. For example, the second user 114b may wave at the first user 114a.

At step 912, the application server 102 is configured to receive the user(s) “waved at” by the second user 114b. In one example, the user engine 109 of the application server 102 is configured to save a wave status of the second user 114b corresponding to the user(s) selected by the second user 114b to “wave at” (e.g., the first user 114a). In some examples, the user engine 109 can save the wave status of the second user 114b in the user database 112b.

At step 914, the user engine 109 is configured to check the wave status of the second user 114b for a wave match. In one example, the user engine 109 can check the wave status of the second user 114b by comparing the wave status of the second user 114b to the wave statuses of other users (e.g., the first user 114a). The user engine 109 may find a wave match when the wave statuses indicate that two or more users have waved at each other (e.g., the first and second users 114a, 114b).

At step 916, in response to finding a wave match between the first user 114a and the second user 114b, the room engine 106 is configured to generate and start an audio room 104. In one example, the room engine 106 is configured to generate an audio room instance corresponding to the first user 114a and the second user 114b. For example, the audio room 104 may have a room title 122 corresponding to the names of the users 114a, 114b (e.g., “Chat between John and Mike”). In some examples, the audio room 104 is generated as a private (or closed) room including only the first and second users 114a, 114b. Likewise, each user 114a, 144b can be added to the audio room 104 as a speaker. The room engine 106 may start the audio room 104 by launching the generated audio room instance on the application server 102 (or a different server). Once started, the audio room 104 may be opened up by the first user 114a (or the second user 114b) and made visible to friends of the first user 114a and/or the second user 114b. In some examples, room invites can be sent to other “waved at” users, as described above.

While the above example describes an audio room corresponding to a wave match between two users (e.g., the first and second users 114a, 144b), in other examples, audio rooms can be created based on a wave match between three or more users. For example, when checking the wave status of each user, the room engine 106 may find three or more users who have waved at each other. As such, the room engine can generate an audio room for the three or more users.

As described above, the user 114 can cancel active waves by selecting (or tapping) a button in the user interface 120 (e.g., the button 1042 of FIG. 10G). In some examples, the active waves of a user can be suspended or canceled automatically. For example, the active waves of a user may be suspended when the user 114 is not in an audio room and exits the client application 118 (without closing the client application 118). In other words, the active waves may be suspended when the client application 118 is running in the background of the user device 116. Likewise, the active waves can be suspended when the user 114 joins a stage in an audio room (i.e., becomes a speaker). As such, the waves can be unsuspended when the user 114 reopens the client application 118 or leaves the stage of the audio room. In some examples, the suspended waves may be automatically canceled (or dismissed) after being suspended for a defined period of time (e.g., 10 minutes). It should be appreciated that wave matching features of steps 910-916 may be optional features of the system 100.

### Discovering Active Users

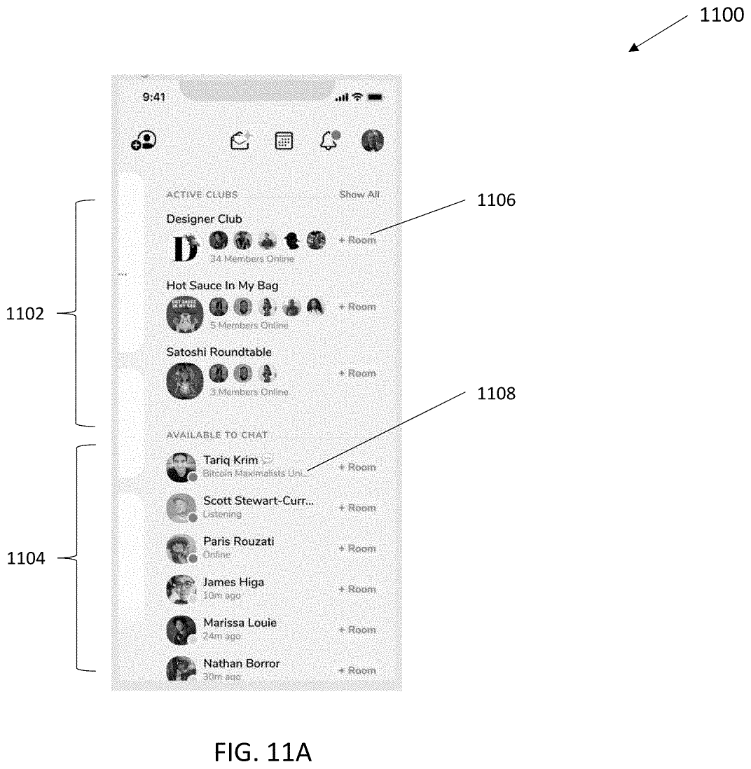

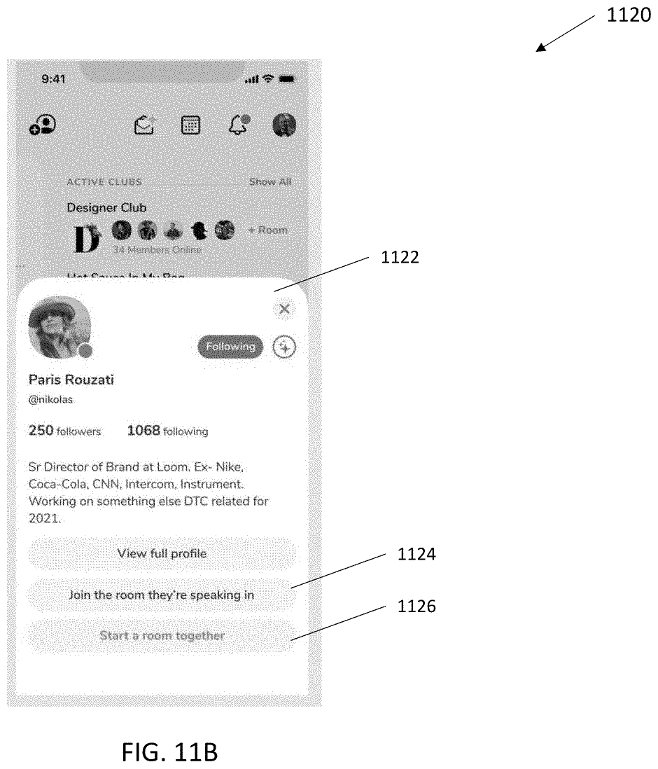

When determining who to speak with, it may be beneficial for users to view a list of users who are actively using the platform (or were recently using the platform). For example, FIG. 11A illustrates an example view 1100 of the user interface 120. In one example, the user 114 can navigate to the view 1100 by swiping in a specific direction (e.g., right) on the home screen of the user interface 120 (e.g., view 200 of FIG. 2). In some examples, the view 1100 corresponds to a “sidebar.” The sidebar can be displayed within the same environment and/or executed by the same application as the platform. As shown, an active club list 1102 and an active user list 1104 are displayed to the user 114. In one example, the active club list 1102 includes clubs having at least one active member on the platform. The clubs included in the list 1102 may correspond to clubs that the user 114 is a member of In some examples, only certain club members may have permission to start audio rooms associated with the club. As such, the clubs included in the list 1102 may only include clubs that the user 114 is allowed to start audio rooms for. The user 114 may select a room button 1106 next to each club to start (or request to start) a live audio room including the active members of each club.

Similarly, the active user list 1104 includes users who are actively using the platform or were recently using the platform. In one example, the user list 1104 includes active users who are in an audio room 104 (e.g., as a speaker or audience member), active users who are browsing the platform, and/or inactive users who were previously on the platform. In general, the list 1104 can be populated with any collection of users; for example, the users included in the list 1104 can correspond to co-followers or friends of the user 114. The inactive users included in the list 1104 may correspond to users who have been inactive for less than a predefined period of time (e.g., 5 mins, 10 mins, 20 mins, 30 mins, 1 hour, or a time selected by a user). A status indicator 1108 can be included under the name of each user in the list 1104. The status indicator 1108 may provide information corresponding to the current state of each user. For example, if a user is participating in an audio room, the status indicator 1108 may include the title of the audio room and/or an indication of the user's role in the audio room (e.g., “Speaking” or “Listening”). Likewise, if a user is browsing the platform, the status indicator 1108 may indicate that the user is online (e.g., “Online”). For inactive users included in the list 1104, the status indicator 1108 may show the amount of time that has elapsed since the user was last active (e.g., “24 m ago”). The user 114 may select the room button 1106 next to each active user in the list 1104 to join (or request to join) the same audio room as the active user. If the user is not in an audio room (or inactive), the user 114 may select the room button 1106 next to each user to start (or request to start) a new audio room.

In some examples, the first user 114a can select each user included in the user list 1104 to view the user's profile. For example, FIG. 11B illustrates an example view 1120 of the user interface 120 including a user profile tab 1122. In one example, the user profile tab 1122 is displayed when the user 114 selects a user from the user list 1104. As shown, the user profile tab 1122 includes a join room button 1124 and a start room button 1126. If the selected user is speaking (or listening) in a live audio room, the user 114 may select the join room button 1124 to join (or request to join) the same audio room. Likewise, the user 114 can select the start room button 1126 to start (or request to start) a new audio room with the selected user. In some examples, the active club list 1102 and the active user list 1104 are managed and updated by the user engine 109.

### Hand Raise Queue

As discussed above, audience members in an audio room 104 can request speaking privileges during the live audio conversation (e.g., via the speaker request button 414 of FIG. 4B). The requests may be granted by one or more speakers in the audio room 104. This request-based system prevents the moderators (e.g., speakers) from having to check with each audience member to see if they would like to participate in the discussion. However, the speakers may receive many requests during an audio room session, including requests from users that they do not recognize (i.e., strangers). As such, a hand raise queue system can be used to manage the requests received during a live audio discussion.

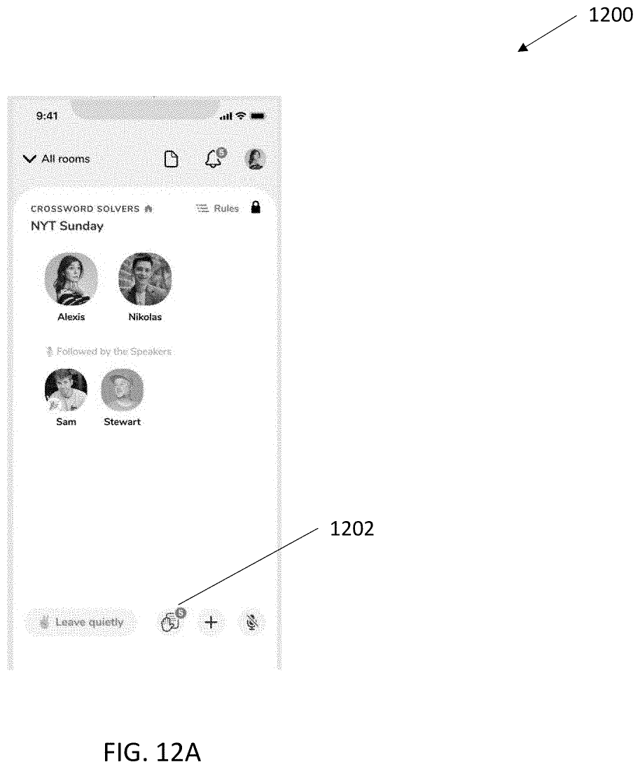

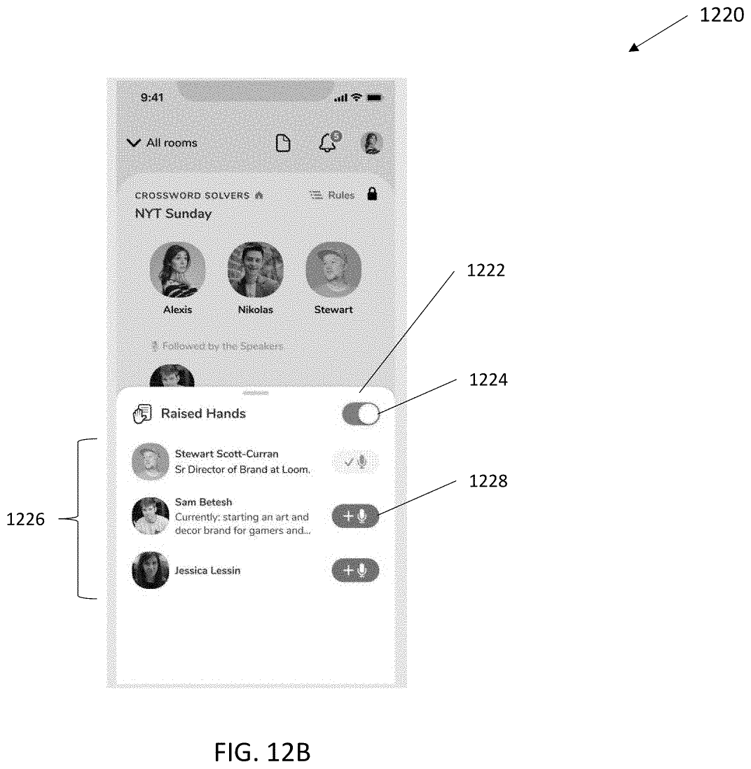

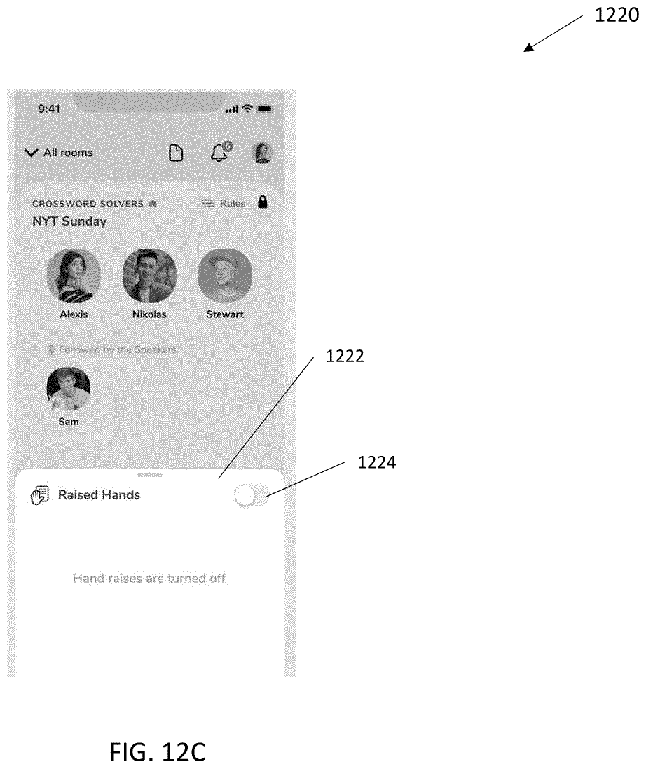

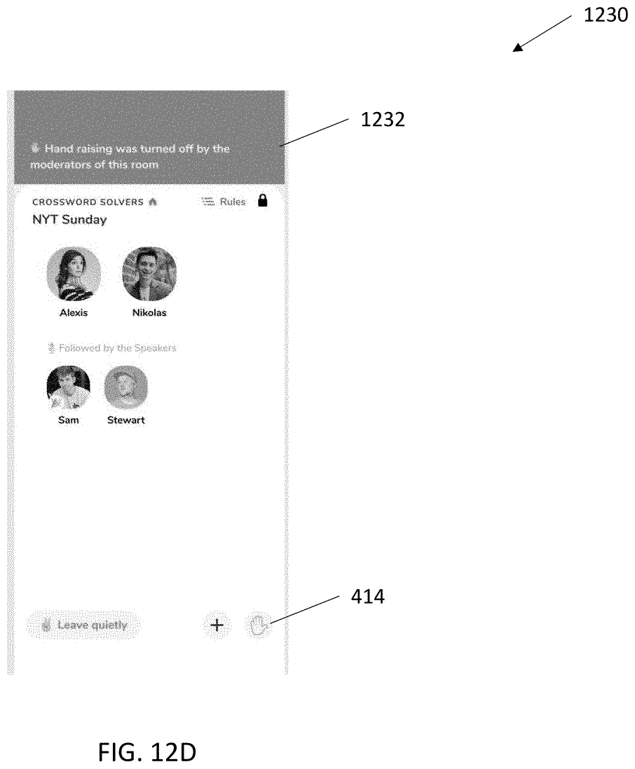

FIG. 12A is an example view 1200 of the user interface 120. In one example, the view 1200 corresponds to a live audio room 104 from the perspective of a speaker (e.g., user 114). As shown, a queue button 1202 is included allowing the user 114 to view the number of speaking requests received. In some examples, the user 114 can select the queue button 1202 to view the hand raise queue. For example, FIG. 12B illustrates an example view 1220 of the user interface 120 including a hand raise queue tab 1222. In one example, a hand raise toggle 1224 is included allowing the user 114 (or other speakers) to enable or disable hand raises (i.e., speaking requests). For example, hand raises may be disabled if the intention of the audio room is to keep the same set of speakers. If hand raises are enabled, a user list 1226 is displayed and dynamically updated as new speaking requests are received. In general, any suitable criteria can be used to determine the order in which speaking requests are displayed. In one example, users (i.e., audience members) are arranged in the user list 1226 based on the order in which the requests are received. In other words, the users who submitted the earliest speaking requests are displayed at the top of the list 1226 and the users who submitted the latest (or most recent) speaking requests are added to the bottom of the list 1226. In other examples, the users in the user list 1226 can be arranged using a weighting criteria. For example, users who co-follow one or more speakers and/or users who have a large number of followers (e.g., celebrities, athletes, etc.) may automatically be displayed at the top of the list 1226. In some examples, the users who can request to speak (i.e., join the queue) may be limited by the speaker(s). For example, the hand raise queue may be restricted to users who follow (or co-follow) one or more speakers. If the audio room is associated with a club, the hand raise queue may be restricted to users who are members of the club. The user 114 (or other speakers) can enable/disable speaking privileges by selecting a speech button 1228 next to each user in the list 1226.

As shown in FIG. 12C, the user list 1226 is not displayed to the user 114 (or the other speakers) when hand raises are disabled (e.g., via the hand raise toggle 1224). In some examples, the state of the user list 1226 may be saved and restored if hand raises are re-enabled within a predefined window (e.g., less than 5 mins). In other examples, the hand raise queue is reset each time hand raises are enabled/disabled. The audience members may be notified or alerted each time hand raises are enabled/disabled. For example, FIG. 12D is an example view 1230 of the user interface 120 corresponding to a live audio room 104 from the perspective of an audience member. In one example, the user interface 120 is configured to display an alert (or toast) 1232 each time hand raises are enabled/disabled. In certain examples, the speaker request button 414 is enabled and disabled accordingly. In some examples, the hand raise queue is managed and updated by the room engine 106.

### Audio Room Replays

In some examples, audio room discussions can be recorded for future replays. An audio room may be recorded and stored such that audio room participants (e.g., speakers and audience members) can revisit or reexperience the audio room. In addition, users who missed the live audio room may listen to the audio room discussion via the replay. In one example, the audio room replays can be stored in the application database 112a and presented to users on demand via the room engine 106. In some examples, after listening to an audio room replay, the user may be included (or recorded) as an audience member participant for said audio room. In other examples, a distinction between live audience members and replay audience members may be recorded (e.g., in the user database 112b).

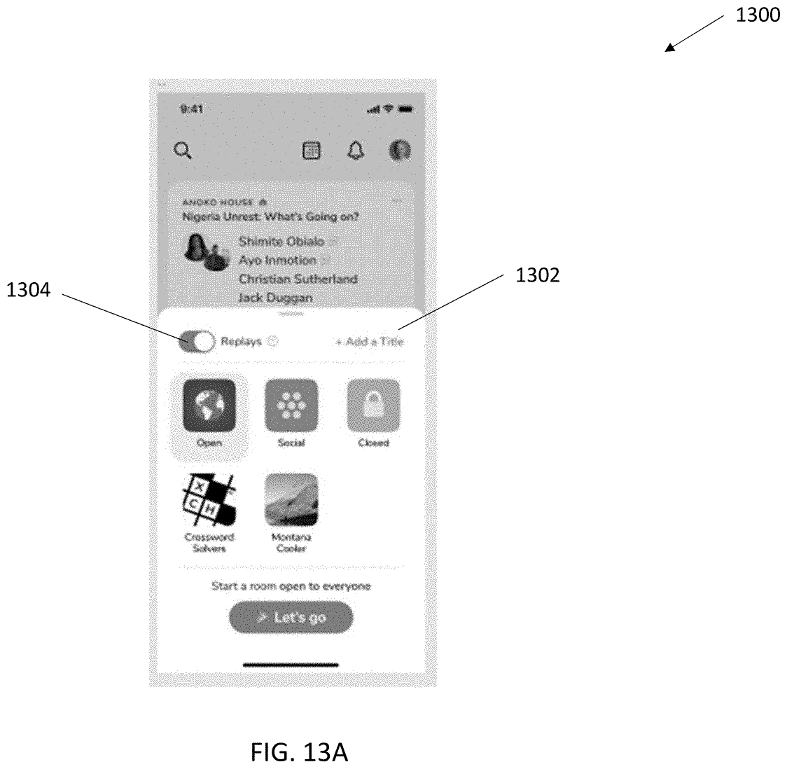

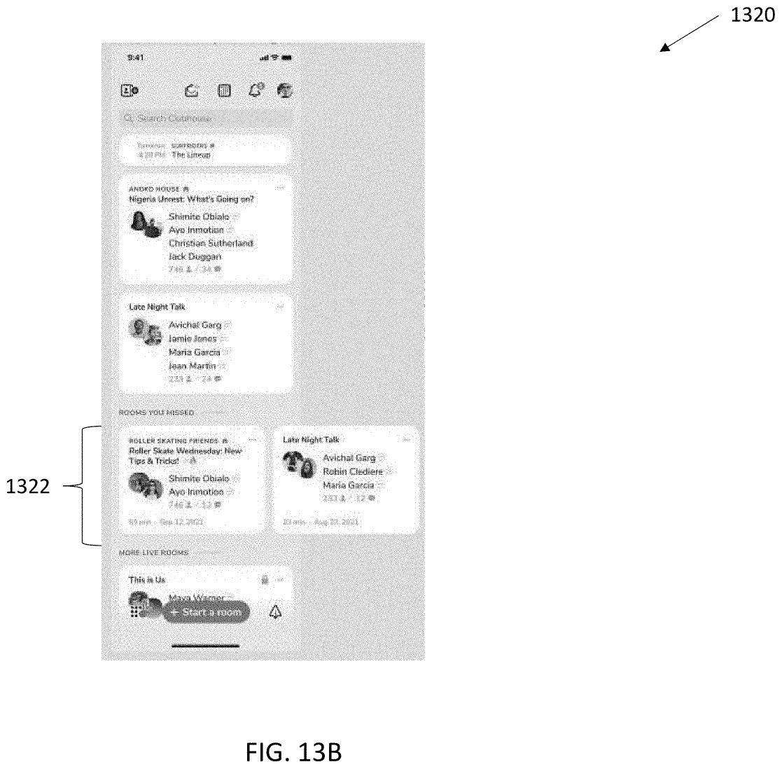

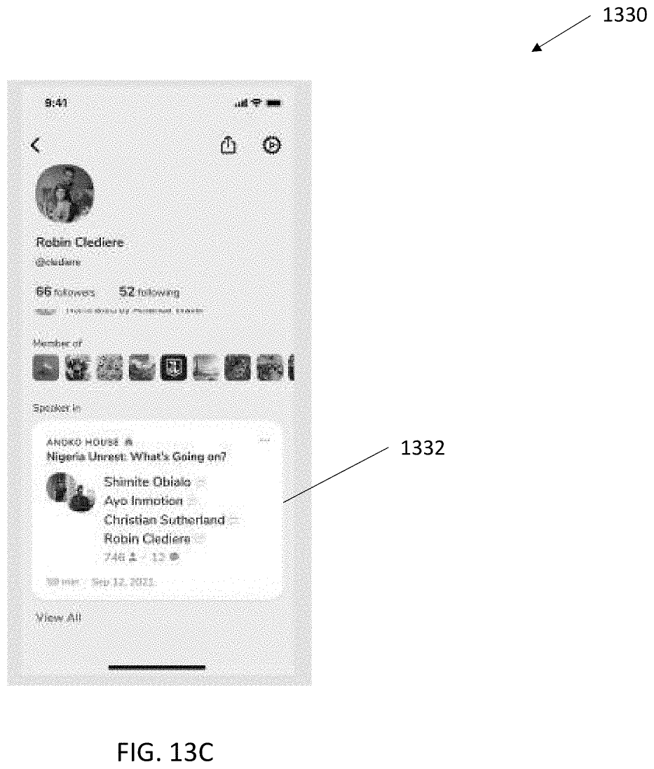

FIG. 13A illustrates an example view 1300 of the user interface 120 including a start room tab 1302. In one example, a replay toggle 1304 is included allowing the user to enable or disable replays (i.e., recording). In some examples, replays can be enabled or disabled at any point prior to the start of the audio room and/or at any time during the audio room. In certain examples, only speakers (or creators) of the audio room may enable or disable replays. While not shown, replays can be enabled/disabled for scheduled audio rooms. In one example, a notification, status, or alert is provided to audio room participants indicating that the audio room is being recorded for replay. In some examples, audience members can elect to hide their user profile (or user name) in audio rooms that are being recorded. As such, these users may remain hidden during replays of the recorded audio room.

Once recorded, the audio room replays can be presented to users. For example, FIG. 13B illustrates an example view 1320 of the user interface 120 that presents audio room replays to the user. As shown, a scrollable list 1322 of audio room replays can be presented to the user along with live audio rooms in the “hallway” configuration. In one example, each audio room replay is displayed with the discussion length and the recording date. If applicable, each audio room replay may be displayed with the audio room title and/or an associated club name. The number of audio room participants (e.g., speakers and audience members) may also be displayed with the audio room replay. In some examples, the names of speakers who participated in (or created) the recorded audio room may be displayed. Similarly, the audio room replays can be presented in the user profile of each speaker. For example, FIG. 13C illustrates an example view 1330 of the user interface 120 corresponding to a user profile. As shown, the user profile can include audio room replays 1332 in which the user participated as a speaker. In one example, the user profile is configured to display the latest audio room replay corresponding to the user; however, in other examples, the user profile may display multiple audio room replays. Users can elect to remove one or more audio room replays from their own user profile. While not shown, audio room replays can be included with a club profile in a similar manner. In certain examples, audio room replays can be displayed as search results in the client application 118 (e.g., via a search function).

In some examples, the audio room replays are generated by temporally arranging audio streams captured from the user devices 116 of each speaker in the live audio room. In one example, the audio stream of each device 116 corresponds to the microphone input from each speaker. The audio streams may be encrypted by the client application 118 or the room engine 106. In some examples, the encrypted audio streams are provided to an audio stream aggregator configured to temporally arrange (or stitch) the audio streams together. The audio streams may be decrypted before being combined into the combined audio stream. In one example, the audio stream aggregator is included as an application or engine on the application server 102; however, in other examples, the audio stream aggregator may be included as an application or engine on a different server. The combined audio stream can be saved as the audio room replay in the application database 112a. In some examples, the combined audio stream is encrypted before being stored. Upon request, the combined audio stream can be retrieved from the application database 112a and provided to a user for presentation via the room engine 106. In some examples, the combined audio room stream is decrypted by the room engine 106 or the client application 118 prior to playback.

### Audio Room Transcripts

In some examples, audio room discussions can be transcribed for live (or future) viewing. An audio room may be transcribed and the transcript stored such that audio room participants (e.g., speakers and audience members) can view or revisit the audio room discussion. In one example, the audio can be transcribed in real-time to provide a closed captioning service for the audio room. In addition, users who join the audio room late (e.g., in the middle of the discussion) may review the audio room transcript to catch up. Likewise, users who miss the live audio room entirely may review a stored copy of the transcript. In one example, the audio room transcript can be stored in the application database 112a and presented to users on demand via the room engine 106. In some examples, after reviewing an audio room transcript, the user may be included (or recorded) as an audience member participant for said audio room. In other examples, a distinction between live audience members and users who only review the audio room transcript may be recorded (e.g., in the user database 112b).

In one example, a transcript toggle is included in the user interface 120 allowing users (e.g., speakers) to enable or disable transcripts (or the presentation of transcripts). In some examples, transcripts can be enabled or disabled at any point prior to the start of the audio room and/or at any time during the audio room. In certain examples, only speakers (or creators) of the audio room may enable or disable transcripts (or the presentation of transcripts). Likewise, transcripts can be enabled/disabled for scheduled audio rooms. In one example, a notification, status, or alert is provided to audio room participants indicating that a speech recognition function is being applied to the audio room and the associated audio streams for the purposes of providing (or collecting) transcripts. In some examples, speakers can elect to disable transcripts for their own audio streams. In other words, a speaker may withhold their contributions to the audio room discussion from the audio room transcript (or presentation of the audio room transcript).

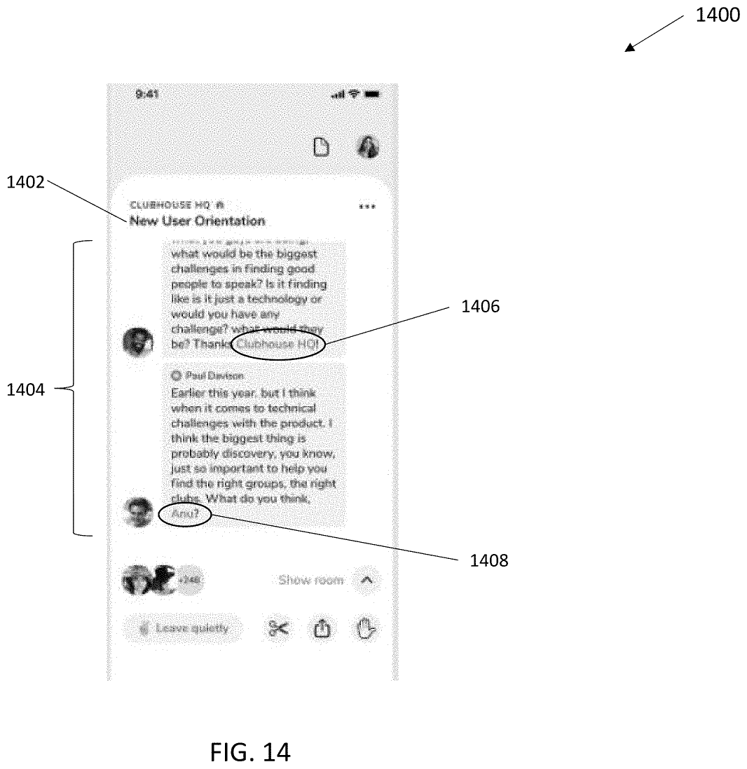

As described above, the audio room transcripts can be presented to users in real time and/or for later viewings. FIG. 14 illustrates an example view 1400 of the user interface 120 that presents an audio room transcript to the user. As shown, the user interface 120 is configured to display the room name 1402 and a corresponding message thread 1404. If applicable, a club name may also be displayed. During a live audio room, the message thread 1404 is dynamically updated with new messages representing the live audio discussion and the associated speakers. The message thread 1404 provides a speaker-to-speaker history of the audio room. Each speaker and what they said can be displayed in a message bubble. The message bubbles are chronologically ordered by the progression of the discussion. Each message bubble can be read or listened to, or exported for sharing with other users. During later viewings, the message thread 1404 corresponds to a scrollable list that includes all messages (i.e., speaker contributions) that represent the audio room discussion. In some examples, during an audio room replay, the message thread 1404 can be dynamically updated with messages as if the audio discussion were live. Alternatively, the entire message thread 1404 may be displayed at the beginning of an audio room replay, allowing the user to scan the discussion and skip to relevant or interesting sections of the audio room replay. In certain examples, the individual messages in the message thread 1404 are time stamped and temporally linked to the corresponding sections (e.g., sound bites) of the audio room replay.

In one example, the message bubbles included in the message thread 1404 can be displayed differently based on the speaker. For example, a user's own messages (i.e., discussion contributions) may be displayed on the right side of the message thread 1404, while messages associated with other speakers may be displayed on the left side of the message thread 1404. Likewise, messages associated with original speakers (or creators) of the audio room may be shown on the left side of the message thread 1404, while messages associated with temporary speakers (e.g., audience members granted speaking privileges) may be displayed on the right side of the message thread 1404. Similarly, messages associated with club members may be shown on the left side of the message thread 1404, while messages associated with guests (e.g., non-club members) may be displayed on the right side of the message thread 1404. While the above examples describe displaying message bubbles on different sides of the message thread 1404, it should be appreciated that different message bubble attributes can be used to distinguish message types (e.g., message color).

In some examples, the message bubbles included in the message thread 1404 can include interactive links. For example, a club link 1406 is provided in a message that specifically mentions a club name. The user viewing the message thread 1404 may select the club link 1406 to view the club's profile. In addition, a user link 1408 is provided in a message that specifically mentions a user's name. The user viewing the message thread 1404 may select the user link 1408 to view the user's profile. In each case, the user may navigate to the linked club/user profile without leaving the audio room. In certain examples, the clubs and/or users that can be linked in the message thread 1404 may be restricted to those relevant to the audio room. For example, the pool of users that can be linked may be limited to those participating in the audio room (e.g., speakers and audience members).

Audio room transcriptions can be used by the application to provide better understanding of the content and context of the audio room discussions to help improve and personalize the service. For example, analysis of the audio room transcriptions can help the application understand what subjects the discussion in the audio room related to and use that to help users discover relevant audio room replays. The audio room transcriptions can also be used to identify content that violates an application's content moderation policies.

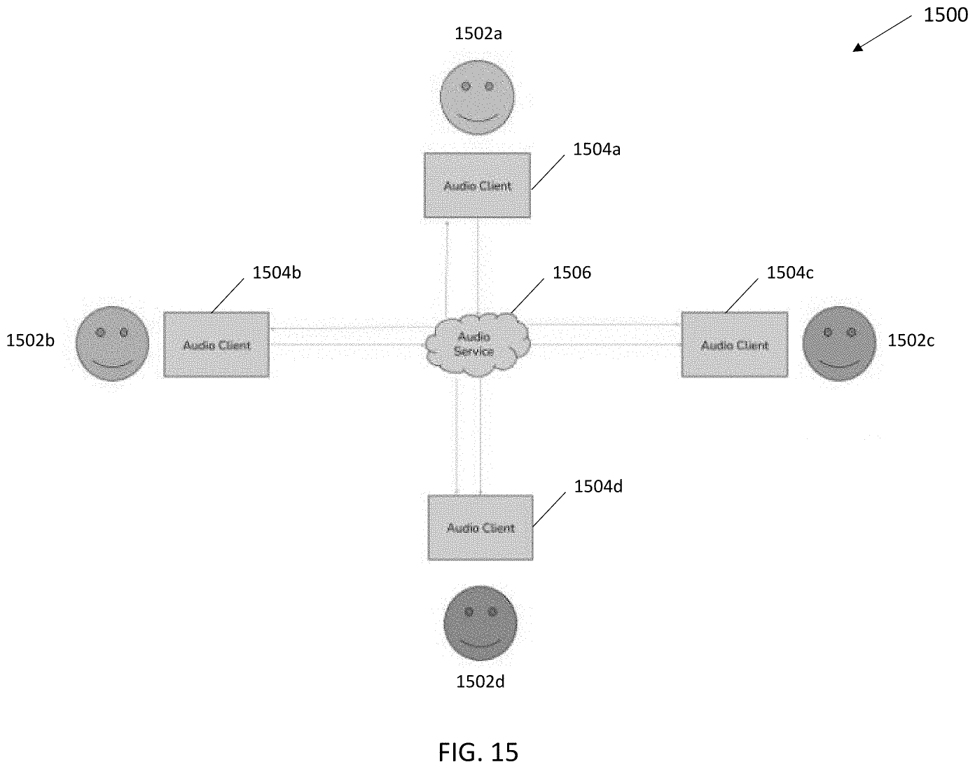

Various processing techniques can be applied to improve the accuracy and quality of the audio room transcriptions. FIG. 15 is a block diagram of an audio service arrangement 1500 in accordance with aspects described herein. The audio service arrangement 1500 represents the flow of audio streams within an audio room (e.g., audio room 104). As shown, the audio service arrangement 1500 includes a plurality of users 1502, a plurality of audio clients 1504, and an audio service 1506. In one example, the plurality of users 1502 includes a first user 1502a, second user 1502b, a third user 1502c, and a fourth user 1502d; however, in other examples, the audio service arrangement 1500 can include a different number of users.

In one example, each audio client of the plurality of audio clients 1504 is included in the client application 118 (e.g., running on user devices 116). In some examples, the audio service 1506 is included as an application or engine on the application server 102; however, in other examples, the audio service 1506 may be included as an application or engine on a different server.

In the illustrated example, the first and second users 1502a, 1502b are speakers and the third and fourth users 1502c, 1502d are audience members (or listeners). The audio stream corresponding to the first user 1502a is provided from the audio client 1504a and redirected via the audio service 1506 to the audio clients 1504 of the second, third, and fourth users 1502b, 1542c, 1502d. Likewise, the audio stream corresponding to the second user 1502b is provided from the audio client 1504b and redirected via the audio service 1506 to the audio clients 1504 of the first, third, and fourth users 1502a, 1542c, 1502d.

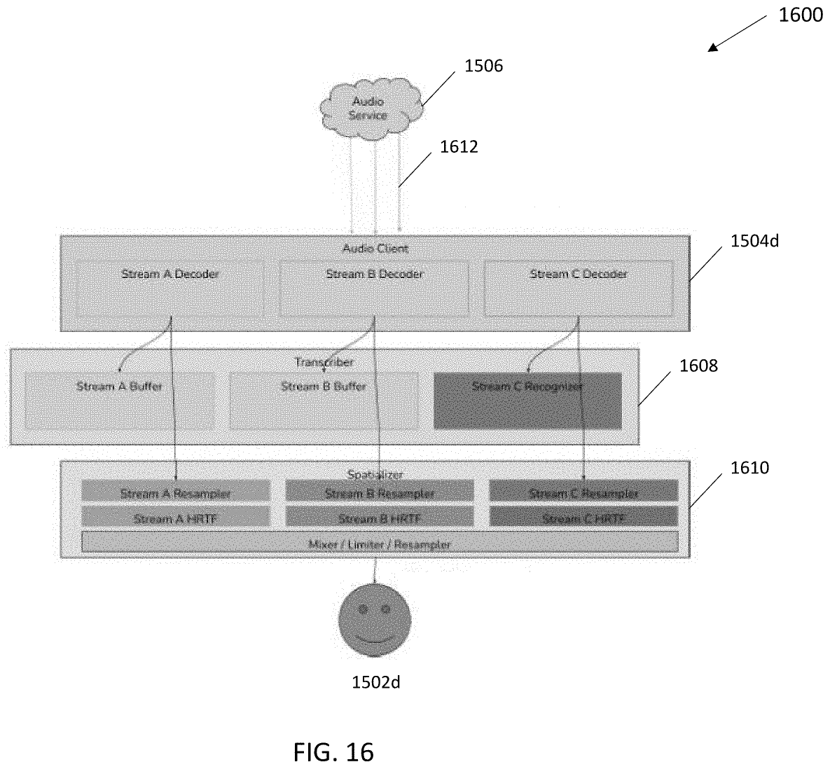

FIG. 16 is a block diagram of an audio processing architecture 1600 in accordance with aspects described herein. The audio processing architecture 1600 represents the flow of audio streams from an audio service (e.g., audio service 1506) to a user in an audio room (e.g., speaker or audience member). In one example, the audio processing architecture 1600 includes a transcriber 1608 and a spatializer 1610.

In the illustrated example, the audio processing architecture 1600 is providing an audio room stream to the fourth user 1502d of FIG. 15. As shown, the audio service 1506 is configured to provide a plurality of audio streams 1612 to the audio client 1504d. In one example, the plurality of audio streams 1612 includes audio streams associated with speakers in the audio room (e.g., the first and second users 1502a, 1502b). In some examples, the plurality of audio streams 1612 are sent to the audio client 1504d as Real-time Transport Protocol (RTP) packets containing audio payloads (e.g., Opus codec payloads). In some examples, the plurality of audio streams 1612 are encoded using a media stream encryption protocol. As such, the audio client 1504d may include one or more decoders configured to decode the plurality of audio streams 1612.

In one example, the decoded plurality of audio streams 1612 are provided to the transcriber 1608 and the spatializer 1610 in parallel. At the spatializer 1610, each audio stream of the plurality of audio streams 1612 is processed for presentation to the user 1502d. In some examples, the spatializer 1610 is configured to resample each audio stream (e.g., down to 24 KHz) and apply a corresponding head-related transfer function (HRTF). The HRTF applied to each audio stream may correspond to the speaker associated with the audio stream. For example, a first HRTF may be applied to the audio stream associated with the first user 1502a such that the first user's 1502a voice appears to be coming from the left side of the room when presented to the listener (e.g., the fourth user 1502d). Likewise, a second HRTF may be applied to the audio stream associated with the second user 1502b such that the second user's 1502b voice appears to be coming from the right side of the room when presented to the listener (e.g., the fourth user 1502d). It should be appreciated that other spatial audio configurations may be implemented and that the configuration described above is provided merely as an example. In some examples, the plurality of audio streams 1612 are mixed (e.g., with a limiter) to avoid audio clipping and resampled again (e.g., up to 48 KHz) before being provided to the fourth user 1502d.

Simultaneously, the plurality of audio streams 1612 are transcribed into text at the transcriber 1608. In one example, the transcriber 1608 includes at least one recognizer module configured to perform the speech-to-text translation. In some examples, the recognizer module processes each audio stream one at a time. For example, the recognizer module may process the audio stream that corresponds to the active speaker at any given time during the audio room discussion. In certain examples, the transcriber 1608 is configured to provide (or stream) the transcribed text to the room engine 106 of the application server 102. The transcribed text may be stored in the application database 112a.

In some examples, the room engine 106 is configured to construct a canonical transcript from multiple individual transcripts (e.g., from each audio client 1504). In an example technique, after transcribing speech locally at each user device 116, each audio client 1504 can upload its version of the transcript to the application server 102 for further processing by the room engine 106. The plurality of transcripts may each differ somewhat due to when users joined (or left) the audio room, processing power of the user device 116, speech models present on the local device, network delivery issues, etc.

In one example, each transcript of the plurality of transcripts is split into utterances (or chunks). The plurality of transcripts are aligned by the chunks (e.g., based on timestamp and/or speaker IDs). For each chunk, the best (or highest quality) transcription can then be identified. In some embodiments, this is done by computing a distance (e.g., Levenshtein distance, Hamming distance, etc.) between the chunk and the same chunk in the other transcripts. In an example using the Levenshtein distance, the best transcription can be identified as the transcript with the lowest Levenshtein distance (treating each word as a token) to the corresponding chunks in the other supplied transcripts. The Levenshtein distance may be an integer value representing the number of words needing insertion, removal, or correction in a given chunk. In certain examples, the transcript with the lowest Levenshtein distance corresponds to the transcript that most resembles all of the other transcripts in a pairwise comparison.

In some examples, once identified, attempts to minimize the Levenshtein distance of the best transcription can be made. For example, such attempts can include swapping in segments (e.g., transcribed words) from the other transcripts and/or inserting alternate representations for a segment from the current chunk. While the above example describes using Levenshtein distances to classify transcripts (or chunks), it should be appreciated that other metrics may be used (e.g., Hamming distance).

In some examples, the transcription quality can be improved by matching the recognizer module to the speaker. In one example, the speech model used by the recognizer module may be selected based on inferred user locale. For example, the room title can be used to infer what language the room is likely in. Similarly, the user's home country can be inferred based on their phone number to indicate likely accents/dialects. These “hints” can be used to select a language and/or country specific speech model(s) for each speaker. In some examples, multiple potential models may be selected for a speaker and the transcriber 1608 can try transcribing with each model to see which gives the best confidence score for the resulting transcription.

In one example, the transcription quality can be improved by transcribing the speaker streams individually, rather than transcribing the mixed audio room stream. As described above, the audio room transcription is performed before the speaker streams are mixed (or stitched) together such that individual speech models can be used for each speaker transcription. In some examples, level differences between the individual speakers can be adjusted (e.g, normalized) prior to performing the transcription. In addition, by transcribing the speaker streams individually, transcription quality can be maintained during doubletalk scenarios where multiple speakers are talking simultaneously. In some examples, the cadence and pitch of each speaker is derived from the individual speaker streams to dynamically tune the recognizer module (or associated speech model) throughout the audio room discussion.

In certain examples, resource allocation techniques can be used to ensure proper transcription of the plurality of streams 1612. For example, some user devices 116 may have limited or restricted processing resources and may only transcribe one stream at a time. As such, the transcriber 1608 may be configured to dynamically determine which stream 1612 should be transcribed at any given time. In one example, the transcriber 1608 is configured to use voice activity detection (VAD) to determine which stream of the plurality of streams 1612 corresponds to the active speaker. In some examples, the individual streams are buffered such that full transcriptions can be captured after the transcriber 1608 has made a determination to switch to another stream.

In some examples, the quality of the transcriptions can be further improved by dynamically providing “hints” to the recognizer module. For example, terms that are likely or expected to be used in the live audio room can be provided to the recognizer module. In certain examples, such hints may be provided to each transcriber 1608 via the room engine 106 or another engine running on the application server 102. Speakers will often refer to other speakers by name, as well as the topic of the room they are talking about, the name of the club, and also materials they may have shared in the room (e.g., pinned links). In some examples, uncommon proper nouns (e.g., names) and domain-specific lingo (e.g., URLs) may be provided to the recognizer module to enhance transcription quality. These hints can change dynamically based on the audio room participants, current room topic, and current pinned links. When attempting to decide between multiple representations of a given speech segment, the recognizer module can give additional weight to these supplied hints and/or correct transcription spelling to match the supplied hints.

### Hardware and Software Implementations

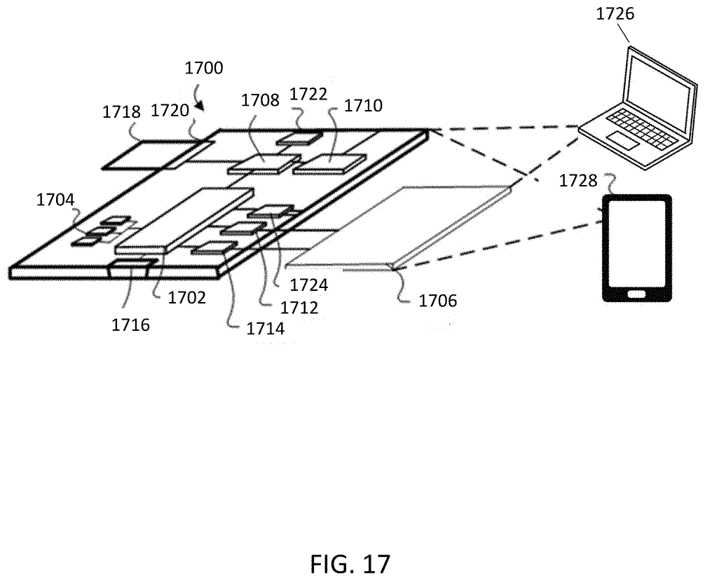

FIG. 17 shows an example of a generic computing device 1700, which may be used with some of the techniques described in this disclosure (e.g., as user devices 116a, 116b). Computing device 1700 includes a processor 1702, memory 1704, an input/output device such as a display 1706, a communication interface 1708, and a transceiver 1710, among other components. The device 1700 may also be provided with a storage device, such as a micro-drive or other device, to provide additional storage. Each of the components 1700, 1702, 1704, 1706, 1708, and 1710, are interconnected using various buses, and several of the components may be mounted on a common motherboard or in other manners as appropriate.

The processor 1702 can execute instructions within the computing device 1700, including instructions stored in the memory 1704. The processor 1702 may be implemented as a chipset of chips that include separate and multiple analog and digital processors. The processor 1702 may provide, for example, for coordination of the other components of the device 1700, such as control of user interfaces, applications run by device 1700, and wireless communication by device 1700.

Processor 1702 may communicate with a user through control interface 1712 and display interface 1714 coupled to a display 1706. The display 1706 may be, for example, a TFT LCD (Thin-Film-Transistor Liquid Crystal Display) or an OLED (Organic Light Emitting Diode) display, or other appropriate display technology. The display interface 1714 may comprise appropriate circuitry for driving the display 1706 to present graphical and other information to a user. The control interface 1712 may receive commands from a user and convert them for submission to the processor 1702. In addition, an external interface 1716 may be provided in communication with processor 1702, so as to enable near area communication of device 1700 with other devices. External interface 1716 may provide, for example, for wired communication in some implementations, or for wireless communication in other implementations, and multiple interfaces may also be used.

The memory 1704 stores information within the computing device 1700. The memory 1704 can be implemented as one or more of a computer-readable medium or media, a volatile memory unit or units, or a non-volatile memory unit or units. Expansion memory 1718 may also be provided and connected to device 1700 through expansion interface 1720, which may include, for example, a SIMM (Single In Line Memory Module) card interface. Such expansion memory 1718 may provide extra storage space for device 1700, or may also store applications or other information for device 1700. Specifically, expansion memory 1718 may include instructions to carry out or supplement the processes described above, and may include secure information also. Thus, for example, expansion memory 1718 may be provided as a security module for device 1700, and may be programmed with instructions that permit secure use of device 1700. In addition, secure applications may be provided via the SWIM cards, along with additional information, such as placing identifying information on the SWIM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1704, expansion memory 1718, memory on processor 1702, or a propagated signal that may be received, for example, over transceiver 1710 or external interface 1716.

Device 1700 may communicate wirelessly through communication interface 1708, which may include digital signal processing circuitry where necessary. Communication interface 1708 may in some cases be a cellular modem. Communication interface 1708 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1710. In addition, short-range communication may occur, such as using a Bluetooth, WiFi, or other such transceiver (not shown). In addition, GPS (Global Positioning System) receiver module 1722 may provide additional navigation- and location-related wireless data to device 1700, which may be used as appropriate by applications running on device 1700.

Device 1700 may also communicate audibly using audio codec 1724, which may receive spoken information from a user and convert it to usable digital information. Audio codec 1724 may likewise generate audible sound for a user, such as through a speaker, e.g., in a handset of device 1700. Such sound may include sound from voice telephone calls, may include recorded sound (e.g., voice messages, music files, etc.) and may also include sound generated by applications operating on device 1700. In some examples, the device 1700 includes a microphone to collect audio (e.g., speech) from a user. Likewise, the device 1700 may include an input to receive a connection from an external microphone.

The computing device 1700 may be implemented in a number of different forms, as shown in FIG. 14. For example, it may be implemented as a computer (e.g., laptop) 1726. It may also be implemented as part of a smartphone 1728, smart watch, tablet, personal digital assistant, or other similar mobile device.

Some implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus.

Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for providing transcripts in online audio discussion forums, the method comprising:
generating an audio discussion forum for a plurality of users, the plurality of users including at least a first user and a second user;
receiving a first audio stream corresponding to first audio content associated with the first user;
receiving a second audio stream corresponding to second audio content associated with the second user, the second audio stream being separate from the first audio stream;
transcribing the first audio content of the first audio stream into first text content;
transcribing the second audio content of the second audio stream into second text content; and
creating a transcript for the audio discussion forum based on the first text content and the second text content.

2. The method of claim 1, wherein receiving the first audio stream corresponding to the first audio content associated with the first user includes receiving the first audio stream from a first user device associated with the first user, and
wherein receiving the second audio stream corresponding to the second audio content associated with the second user includes receiving the second audio stream from a second user device associated with the second user.

3. The method of claim 1, wherein the first audio content includes speech content provided by the first user and the second audio content includes speech content provided by the second user.

4. The method of claim 1, wherein the first audio content includes speech content provided by the first user and speech content heard by the first user, and
the second audio content includes speech content provided by the second user and speech content heard by the second user.

5. The method of claim 1, wherein the first and second audio content are transcribed in parallel.

6. The method of claim 1, wherein the first audio content is transcribed while the first user is speaking and the second audio content is transcribed while the second user is speaking.

7. The method of claim 1, wherein transcribing the first and second audio content includes providing the first and second audio streams to a common speech recognition module.

8. The method of claim 1, wherein transcribing the first audio content includes providing the first audio stream to a first speech recognition module, and
transcribing the second audio content includes providing the second audio stream to a second speech recognition module, the second speech recognition module being different than the first speech recognition module.

9. The method of claim 8, further comprising:
selecting the first speech recognition module from a plurality of speech recognition modules based on at least one characteristic of the first user; and
selecting the second speech recognition module from the plurality of speech recognition modules based on at least one characteristic of the second user.

10. The method of claim 1, further comprising:
analyzing respective sections of the first text content and the second text content corresponding to a portion of an audio discussion in the audio discussion forum;
calculating a first accuracy metric for the first text content section;
calculating a second accuracy metric for the second text content section;
comparing the first accuracy metric to the second accuracy metric; and
based on a result of the comparison, selecting one of the first text content section and the second text content section for inclusion in the transcript for the audio discussion forum.

11. The method of claim 10, wherein the first and second accuracy metrics are Levenshtein distances.

12. The method of claim 10, further comprising:
creating a third text content section by replacing at least a portion of the selected text content section with a respective portion of the unselected text content section;
calculating a third accuracy metric for the third text content section;
comparing the third accuracy metric to the accuracy metric for the selected text content section; and
based on a result of the comparison, adding one of the selected text content section and the third text content section to the transcript for the audio discussion forum.

13. A system for generating an online audio discussion forum, comprising:
at least one memory for storing computer-executable instructions; and
at least one processor for executing the instructions stored on the memory, wherein execution of the instructions programs the at least one processor to perform operations comprising:
generating an audio discussion forum for a plurality of users, the plurality of users including at least a first user and a second user;
receiving a first audio stream corresponding to first audio content associated with the first user;
receiving a second audio stream corresponding to second audio content associated with the second user, the second audio stream being separate from the first audio stream;
transcribing the first audio content of the first audio stream into first text content;
transcribing the second audio content of the second audio stream into second text content; and
creating a transcript for the audio discussion forum based on the first text content and the second text content.

14. The system of claim 13, wherein receiving the first audio stream corresponding to the first audio content associated with the first user includes receiving the first audio stream from a first user device associated with the first user, and
wherein receiving the second audio stream corresponding to the second audio content associated with the second user includes receiving the second audio stream from a second user device associated with the second user.

15. The system of claim 13, wherein the first audio content includes speech content provided by the first user and the second audio content includes speech content provided by the second user.

16. The system of claim 13, wherein the first audio content includes speech content provided by the first user and speech content heard by the first user, and
the second audio content includes speech content provided by the second user and speech content heard by the second user.

17. The system of claim 13, wherein the first and second audio content are transcribed in parallel.

18. The system of claim 13, wherein the first audio content is transcribed while the first user is speaking and the second audio content is transcribed while the second user is speaking.

19. The system of claim 13, wherein transcribing the first and second audio content includes providing the first and second audio streams to a common speech recognition module.

20. The system of claim 13, wherein transcribing the first audio content includes providing the first audio stream to a first speech recognition module, and
transcribing the second audio content includes providing the second audio stream to a second speech recognition module, the second speech recognition module being different than the first speech recognition module.

21. The system of claim 20, wherein execution of the instructions programs the at least one processor to perform operations further comprising:
selecting the first speech recognition module from a plurality of speech recognition modules based on at least one characteristic of the first user; and
selecting the second speech recognition module from the plurality of speech recognition modules based on at least one characteristic of the second user.

22. The system of claim 13, wherein execution of the instructions programs the at least one processor to perform operations further comprising:
analyzing respective sections of the first text content and the second text content corresponding to a portion of an audio discussion in the audio discussion forum;
calculating a first accuracy metric for the first text content section;
calculating a second accuracy metric for the second text content section;
comparing the first accuracy metric to the second accuracy metric; and
based on a result of the comparison, selecting one of the first text content section and the second text content section for inclusion in the transcript for the audio discussion forum.

23. The system of claim 22, wherein the first and second accuracy metrics are Levenshtein distances.

24. The system of claim 22, wherein execution of the instructions programs the at least one processor to perform operations further comprising:
creating a third text content section by replacing at least a portion of the selected text content section with a respective portion of the unselected text content section;
calculating a third accuracy metric for the third text content section;
comparing the third accuracy metric to the accuracy metric for the selected text content section; and
based on a result of the comparison, adding one of the selected text content section and the third text content section to the transcript for the audio discussion forum.
